(19) United States
(12) Patent Application Publication
(10) Pub. No.: US 2015/0019305 A1
(43) Pub. Date: Jan. 15, 2015

(54) SYSTEMS AND METHODS FOR FOLLOWING-UP ON BUSINESS LEADS

(71) Applicant: TRI-FORCE CONSULTING SERVICES, INC., Lansdale, PA (US)

(72) Inventor: Manish M. Gorawala, Ambler, PA (US)

(21) Appl. No.: 14/345,388

(22) PCT Filed: Sep. 17, 2012
(86) PCT No.: PCT/US2012/055828

§ 371 Date: Mar. 17, 2014

Related U.S. Application Data
(60) Provisional application No. 61/535,735, filed on Sep. 16, 2011.

(51) Int. Cl. G06Q 30/02

(52) U.S. Cl. CPC G06Q 30/0241
USPC 705/14.4

(57) ABSTRACT

The present invention relates generally to a method of following-up on business leads, including a system and a non-transitory computer-readable storage medium encoded with instructions for implementing the same. In one embodiment, the invention is directed to an automatic generation of an electronic message based on captured business lead data for a selected business lead and a selected pre-formed message template. In another embodiment, the Invention is directed to displaying a list of business leads associated with, a selected user that have been captured by that user so that the user's business development efforts can be evaluated. In yet another embodiment, the invention is directed to automatically displaying secondary information based on captured business lead data upon selection of a business lead.

### CROSS-REFERENCE TO RELATED APPLICATIONS

The present application claims the benefit of U.S. Provisional Patent Application Ser. No. 61/535:735, filed Sep. 16, 2011, the entirety of which is hereby incorporated by reference.

### FIELD OF THE INVENTION

The present invention relates generally to systems, methods and software for following-up on business leads, and specifically to such systems, methods and software that automate a follow-up communication, allow valuation of personnel in generating business leads, and/or automate the gathering of additional information on a business lead using secondary sources of information.

### BACKGROUND OF THE INVENTION

In today's business environment, a business representative often attend events in which a large number anew contacts are made, such as at tradeshows, business conferences, political meetings and social gatherings. During such events, a single business representative may meet a very large number (potentially hundreds) of new people, each of which is either a potential customer or a business representative for a potential customer. Standard custom during such encounters is to have a brief conversation and exchange physical business cards. Thus, each of these encounters typically results in a business lead.

Under current methods, the business representative has two options to follow-up on the newly obtained business leads: (1) gather a large amount of business cards and, at the end of the event, manually generate an email or other electronic message to each new contact or (2) manually generate an email or other electronic message to each new contact immediately upon receiving the business card (or at intervals) during the event. The first option is less than optimal because the business representative may not actually follow-up on business leads due to the large volume of business leads. Moreover, the business representative may not be able to remember the importance and/or pertinent relevance that each business lead has to his/her business. Thus, the follow-up communication may not be adequately specific and/or personalized to peak the potential customer's interest, thereby leading to failure of the business lead. The second option is also less than optimal in that the business representative's time at the event, which is limited, will be spent creating messages and/or taking notes. Thus, a need exists for an improved, method, system and software no following-up on business leads that at least partially automates the follow-up communication process while at the same still allows for targeted communications.

From a business owner's perspective, an additional problem exists with current procedures for gathering business leads at such events in that the business owner cannot determine whether his/her expenditure in having business representatives is yielding an adequate return on the investment made in having such business representatives attend such events. Moreover, there is no way for the business owner (or other manager) to quickly evaluate and determine which business representatives are the most productive at such events from a business perspective. Thus, a need exists for an improved, method, system and software that allows evaluation of the effectiveness of such business representatives at such events as it relates to business value.

Finally, under current procedures, even if a business lead is generated and followed-up on after the event, there is no easy way to obtain additional information pertaining to the business lead. Thus, a need exists for an improved, method, system and software that allows a user to obtain additional information about as business lead from secondary sources of information with a single click within the same software program in which information on the business lead is displayed.

### SUMMARY OF THE INVENTION

The aforementioned and other needs are met by the present invention which, in one embodiment can be directed to a method, system and non-transitory computer-readable storage medium that automatically generates an electronic message based on captured business lead data for a selected business lead and a selected pre-formed message template. In another embodiment, the invention can be directed to a method, system and non-transitory computer-readable storage medium that display a list of business leads associated with a selected user that have been captured by that user so that the user's business development efforts can be evaluated. In yet another embodiment, the invention can be at method, system and non-transitory computer-readable storage medium that automatically displays, in an interface, secondary information pertaining to a selected business lead based on the exportation of business lead data that is captured and stored in a business lead database by activating an appropriate element.

In one embodiment, the invention can he a method of following-up on business leads, the method comprising: a) storing; one or more pre-formed message, templates in a message template database using business lead management software; b) capturing business lead data for one or more business leads and storing the business lead data in a business lead database using the business lead management software; and c) upon receiving a message formation request for a selected one of the business leads, the business lead management software automatically generating an electronic message using: (1) the business lead data that is stored in the business lead database for the selected business lead; and (2) a selected one of the pre-formed message templates in the message template database.

In another embodiment, the invention can be a non-transitory computer-readable storage medium encoded with instructions which, when executed on a processor, perform a method comprising: a) storing one or more pre-formed message templates in a message template database; b) capturing business lead data for one or more business leads and storing the business lead data in a business lead database; and c) upon receiving a message formation request for a selected one of the business leads, automatically generating an electronic message using: (1) the business lead data for the selected business lead that is stored in the business lead database; and (2) a selected one of the pre-formed message templates in the message template database.

In yet another embodiment, the invention can be a computer system for following-up on business leads, the computer system comprising: a processor; as storage device; a network interface; and instructions residing on the storage unit, which when executed by the processor, causes the processor to: a) store one or more pre-formed message templates in a message template database; b) capture business lead data for one or more business leads and store the business lead data in a business lead database; and c) upon receiving a message formation request for a selected one of the business leads, automatically generate an electronic message using: (1) the business lead data for the selected business lead that is stored in the business lead database; and (2) a selected one of the pre-formed message templates in the message template database.

In still another embodiment, the invention can be a method of evaluating business lead generation by personnel, the method comprising: a) for each of as plurality of users, capturing business lead data using, business lead management software for one or more business leads and storing the business lead data in a business lead database, the business lead management software associating the business lead data with the user whom captured the business lead data; and b) presenting, in as display device, the business lead data stored in the business lead database that is associated with a selected one of the users.

In a further embodiment, the invention can be a non-transitory computer-readable storage medium encoded with instructions which, when executed on a processor, perform a method comprising: a) for each of a plurality of users, capturing business lead data for one or more business leads and storing the business lead data in a business lead database, the business lead management software associating the business lead data with the user whom captured the business lead data; and b) presenting, in a display device, the business lead data stored in the business lead database that is associated with a selected one of the plurality of users.

In an even further embodiment, the invention can be a computer system for following-up on business leads, the computer system comprising: a plurality of electronic devices, each of the electronic devices having a processor, a storage device, a network interface, and instructions residing on the storage unit, which when executed by the processor, causes the processor to: capture business lead data for one or more business leads and store the business lead data in a business lead database; and associate the business lead data with a user whom captured the business lead data; and a remote server in operable communication with the plurality of electronic devices, the remote server comprising a processor, a storage device on which the business lead database resides, a network interface, and instructions residing on the storage unit of the remote server, which when executed by the processor of the remote server, causes the processor of the remote server to: present, in a display device, the business lead data stored in the business lead database that is associated with a selected one of the plurality of users.

In a yet even further embodiment, the invention can be a method of following-up on business leads, the method comprising: a) capturing business lead data for one or more business leads and storing the business lead data in a business lead database using business lead management software; b) the business lead management software presenting, in a display device, a secondary source of information element; c) upon activation of the secondary source of information element, the business lead management software automatically exporting at least a portion of the business lead data of an electronic secondary source of information; and d) presenting, in the display device, an interface in which a result of the electronic secondary source of information based on the exported portion of the business lead data is displayed.

In a still even further embodiment, the invention can be a non-transitory computer-readable storage medium encoded with instructions which, when executed on a processor, perform a method comprising: a) capturing business lead data for one or more business leads and storing the business lead data in a business lead database; b) presenting, in a display device, a secondary source of information element; c) upon activation of the secondary source of information element, automatically exporting at least a portion of the business lead data of a selected, business lead to an electronic secondary source of information; and d) presenting, in the display device, an interface in which a result of the electronic secondary source of information based on the exported portion of the business lead data is displayed.

In even another embodiment, the invention can be a computer system for following-up on business leads, the computer system comprising: a processor; a storage device; a network interface; and instructions residing on the storage unit, which when executed by the processor, causes the processor to: a) capture business lead data for one or more business leads and storing the business lead data in a business lead database using business lead management software; b) present, in a display device, a secondary source of information element; c) upon activation of the secondary source of information element, automatically export at least a portion of the business lead data of an electronic secondary source of information, and d) present, in the display device, an interface in which a result of the electronic secondary source of information based on the exported portion of the business lead data is displayed.

### BRIEF DESCRIPTION OF THE DRAWINGS

he present invention will become more fully understood from the detailed description and the accompanying drawings, wherein:

FIG. 1 is a schematic diagram of a business leads management (“BUM”) system according to one embodiment of the present invention;

FIG. 2 is a simplified flowchart for a method of managing business leads according to an embodiment of the present invention;

FIGS. 3-14 are various graphical user interfaces (GUIs) generated by the BIN software on a mobile electronic device according, to an embodiment of the present invention;

FIGS. 15-37 and 39 are various GUIs generated by the BLM software in a web browser on a computer apparatus according to an embodiment of the present invention;

FIG. 38 is a detailed flowchart for a method of managing business leads according to an embodiment of the present invention;

### DETAILED DESCRIPTION OF THE INVENTION

The following description of the preferred embodiment(s) is merely exemplary in nature and is in no way intended to limit the invention, its application, or uses.

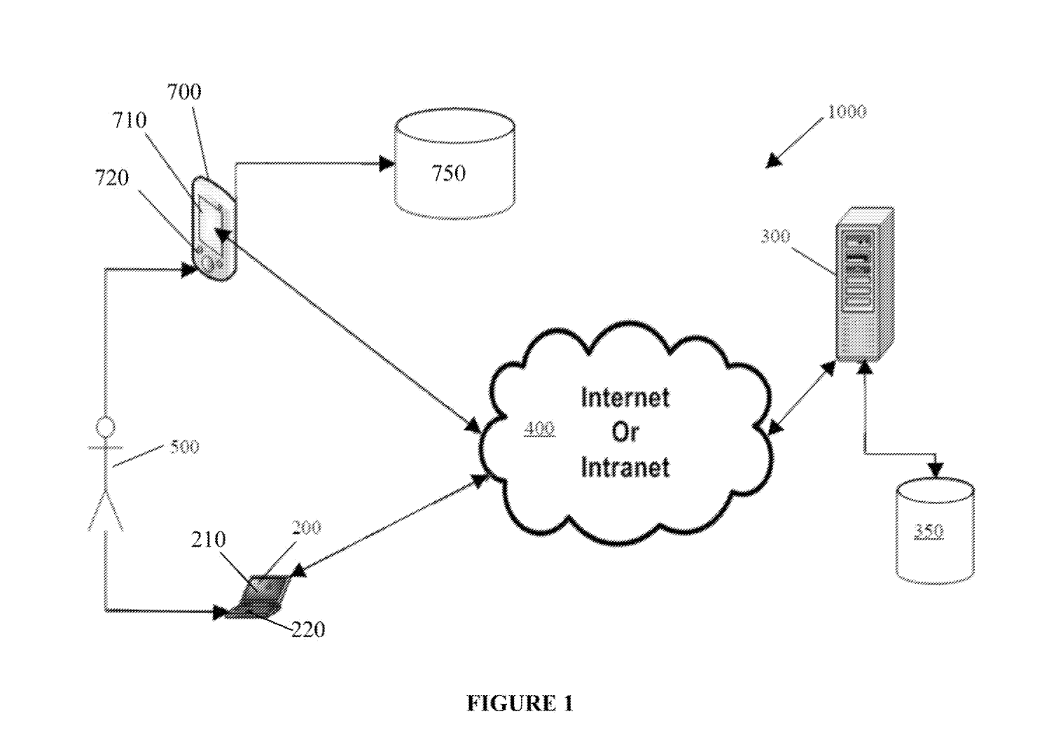

Referring first to FIG. 1, a schematic diagram of a BLM system 1000 is illustrated according to one embodiment of the present invention. From a hardware perspective, the BLM system 1000 generally comprises a BLM server 300, at least one mobile electronic device 100, and a computer apparatus 200. In certain embodiments, the computer apparatus 200 may be omitted from the BLM system 1000. Furthermore, while the BLM system 1000 is exemplified as comprising only one mobile electronic device 100, it is to be understood that in other embodiments, the BLM system 1000 will comprise a plurality of mobile electronic devices 700. In certain such embodiments, each of the plurality of mobile electronic devices 700 has the BLM software (discussed below) installed thereon that is uniquely configured and/or updated for a different one of users 500. In such embodiments, each of the plurality of mobile electronic devices 700 can be the same type of mobile electronic device or can be a different type of mobile electronic device. For purposes of simplicity, the remaining discussion herein will be carried out in relation to the BLM system 1000 comprising a single mobile electronic device 700 with the understanding that if more than one mobile electronic devices 700 was included in the BLM system 1000, the below discussion is applicable to said additional mobile electronic devices 700.

Each of the BUM server 300, the mobile electronic device 700, and the computer apparatus 200 are in operable communication with one another via a wide area network (“WAN”), such as the internet 400. However, the invention is not so limited and other electronic communication means may be utilized, such as a satellite network, a cellular network, a common carrier network(s), WiFi, WiMAX or any combination thereof. Further, it should be noted that operable communication includes any means of electronic communication, such as but not limited to wired and wireless electronic communication, in which data can be transmitted and received, between the components 100, 200, 300 of the BLM system 1000. Moreover, it should also be noted that operable communication includes both direct and indirect communication, as well as bi-directional communication between the components 100, 200, 300 of the system 1000.

In other embodiments, the BLM system 1000 may be configured in other ways Therefore, it should be noted that the invention is not limited only to those configuration explicitly described herein and, in alternate embodiments the BLM system 1000 will take on other configurations and/or layouts. For example, in other embodiments, any and/or all of the components 100, 200, 300 of the BLM system 1000 are connected in operable communication via a local area network (“LAN”), and therefore, may communicate with one another via Ethernet and/or Wi-Fi over the LAN.

The BLM server 300 comprises those hardware and software components as is generally known in the art for servers. For example, the BIM server 300, in certain embodiments, comprises a properly programmed processor (or central processing unit (CPU)), a network interface, and a memory device all in operable communication with one another. Further, although exemplified as a single server, the invention is not so limited and in alternate embodiments, the BLM server 300 may comprise any number of servers in operably communication with one another. Additionally, in certain embodiments, the processor of the BLM server 300 includes integrated memory. The network interface connects the BLM server to the internet 400 so that communication with and/or between the computer apparatus 200 and the mobile electronic device 700 can be accomplished.

Residing on a memory device within the BLM server 300 is the BLM software (or at least a centralized portion thereof) that includes the necessary code with instructions which, when executed on the processor, performs the functioning described below for the BLM software, including, the generation of all necessary graphical user interfaces (GUIs), storage of data, association of data, parsing of data, transmission of data, analysis of data, response to user inputs, interactions with the mobile electronic device 100, interactions with the computer apparatus 200 etc. Also residing on the BLM server 300 is BLM database 350 which stores all of the business lead data, event data, user data, and pre-formed message templates, including proper association between said data, as described in greater detail below. While the BLM database 350 is exemplified as a single database, it can conceptually be considered as comprising a plurality of databases, including a business lead database, an event database, a message template database, and a user database. The BLM database 350 of BLM server 300 is a master BLM database in certain embodiments. In certain regards the term “master,” as used herein in comparison to the term “local,” indicates that the BLM database 350 of the BLM server 300 includes all of the business lead data, all of the event data, all of the pre-formed message templates, and all of the user data that is captured (or otherwise entered) by all of the mobile electronic devices 700 and all of the computer apparatus 200 that form part of the BLM system 1000, as opposed to a “local” BLM database 150 of the mobile electronic devices 700 that stores only that business lead data, event data, pre-formed message templates, and user data that is captured (or otherwise entered) by that mobile electronic devices 700 and/or is associated with the user 500 that is verified for that mobile electronic devices 700.

In certain other regards the term “master,” as used herein in comparison to the term “contemporary,” indicates that the BLM database 350 of the BLM server 300 includes all of the business lead data, all of the event data, all of the pre-formed message templates, and all of the user data that is captured (or otherwise entered) by any one (or all) of the mobile electronic devices 700 and any one (or all) all of the computer apparatus 200 that form part of the BLM system 1000 over the entire history of the BLM system 1000, as opposed to a “contemporary” BLM database 150 of the mobile electronic devices 700 that stores only that business lead data, event data, pre-formed message templates, and user data that is captured (or otherwise entered) by that mobile electronic devices 700 and/or is associated with the user 500 that is verified for that mobile electronic devices 700 for a pre-determined recent period of time. For example, for a specific user 500, the contemporary BLM database 150 of the mobile electronic devices 700 to which that user 500 is verified may only includes business lead data, event data, pre-formed message templates, and user data that is dated within seven days of the current date. Management of the data (e.g., deleting data that is aged beyond a predetermined threshold) in the contemporary BLM database 150 is accomplished by the BLM software that resides either on that mobile electronic device 700 or that resides on the BLM server 300 during a data synchronization process. This prevents overloading of the limited memory capabilities of the mobile electronic devices 700. On the other hand, the master BLM database 350 of the BLM server 300 will include all business lead data, event data, pre-formed message templates, and user data irrespective of the date/age of such data and thus, is essentially an archive of all data irrespective of data age.

While in the exemplified embodiment, the BLM database 350 is shown as a single database that conceptually comprises the sub-databases mentioned above, in other embodiments, the data stored by the BLM software can be spread out over multiple separate databases if desired. hr one such embodiment, the BLM server 300 may comprise separate ones of a business lead database, an event database, a message template database, and a user database. Each of these databases, whether separate or unified in a single database, are, in certain embodiments, simple data tables having the desired association between data and/or cells (intra-database or inter-database) as defined by the BLM software. Finally, from the user's perspective, the BLM server 300 can be considered a “cloud” server while the BLM database 350 can be considered a “cloud” database in which data is stored and maintained.

The mobile electronic device 700 comprises those hardware, firmware and software components as is generally known in the art for mobile electronic devices. For example, the mobile electronic device 700 generally comprises a properly programmed processor, a memory device, a power supply, a video card, a display device 710, firmware, software, a network interface and a user input device 720 (e.g., a keyboard, a mouse, a touch controller, and/or a touch screen). The processor of the mobile electronic device 700 has integrated memory in certain embodiments. The network interface connects the mobile electronic device 700 to the internet 400 so that communication with the computer apparatus 200 and/or the BLM server 300 can be accomplished.

Residing on a memory device within the mobile electronic device 700 is the BLM software (or at least a client portion thereof) that includes the necessary code with instructions which, when executed on the processor, performs the functioning described below for the BLM software, including the generation of all necessary GUIs, storage of data, association of data, parsing of data, transmission of data, analysis of data, response to user inputs, interactions with the BLM server 300, interactions with the computer apparatus 200 etc. As is known and has become very popular in the art, the BLM software for at least a client portion thereof) that resides on the mobile electronic device 700 is stored and displayed thereon as an executable application (commonly referred to as “app”).

The mobile electronic device 700 also comprises a camera device capable of capturing real-world images as image files that are stored within the memory of the mobile electronic, device 700. In certain embodiments, the camera device can act as a matrix bar code scanner through the implementation of such technology as Quick Response Code (“QRCode”) technology. The code necessary to allow the camera device can to act as a matrix bar code scanner can either be part of the BLM software or can be a separate and distinct software package with which the BLM software interfaces to capture business lead data from business cards, or other objects, containing a matrix bar code which comprises encoded business lead data.

The mobile electronic device 700 can take on a wide array of physical embodiments, including without limitation a smartphone, a electronic notepad, electronic personal data assistants, cellular phones, lap tops, or other mobile electronic apparatus that have network communication capabilities, Popular examples include, without limitation, iPhones®, iPads®, Android® Devices, and Blackberry® Devices.

The computer apparatus 200 comprises those hardware, firmware and software components as is generally known in the art for computer apparatus. For example, the computer apparatus 200 generally comprises a properly programmed processor, a memory device, a power supply, a video card, a display device 210, firmware, software, a network interface and a user input device 220 (e.g., a keyboard, a mouse, a touch controller, and/or a touch screen). The processor of the computer apparatus 200 has integrated, memory in certain embodiments, the network interface connects the computer apparatus 200 to the Unmet 400 so that communication with the mobile electronic device 700 and/or the BLM server 300 can be accomplished.

The computer apparatus 200 access the BLM software residing the server 300 via a portal, such as a website that is displayed in a web browser software package that resides on the memory of the computer apparatus. As such, the computer apparatus 200 can be used so that a user or a manage can view the GUI's generated by the server 300 that depict data captured and other information rendered by the BLM software. While the computer apparatus 200 is exemplified as being, in operable communication with the BLM server 300 via the interne 400, the computer apparatus 200 can be coupled directly to the BUM server 300 in other embodiments, or through a LAN network. The computer apparatus 200 can be a lap top computer, a desk top computer or other computer device having sufficient data processing and memory capabilities.

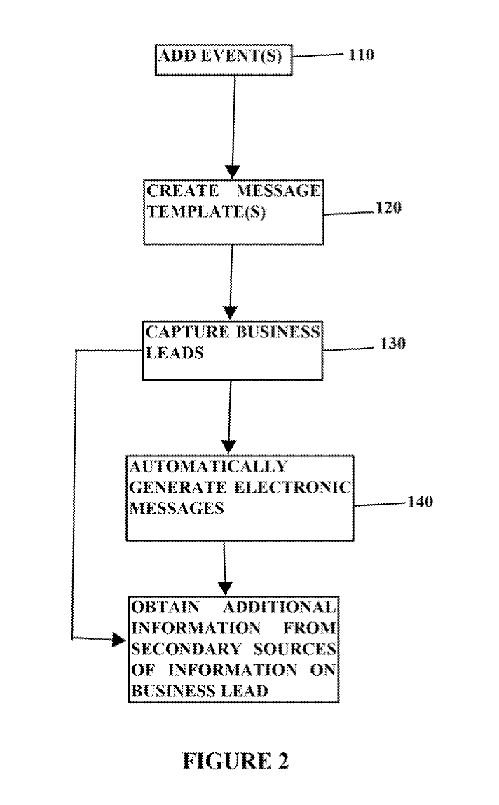

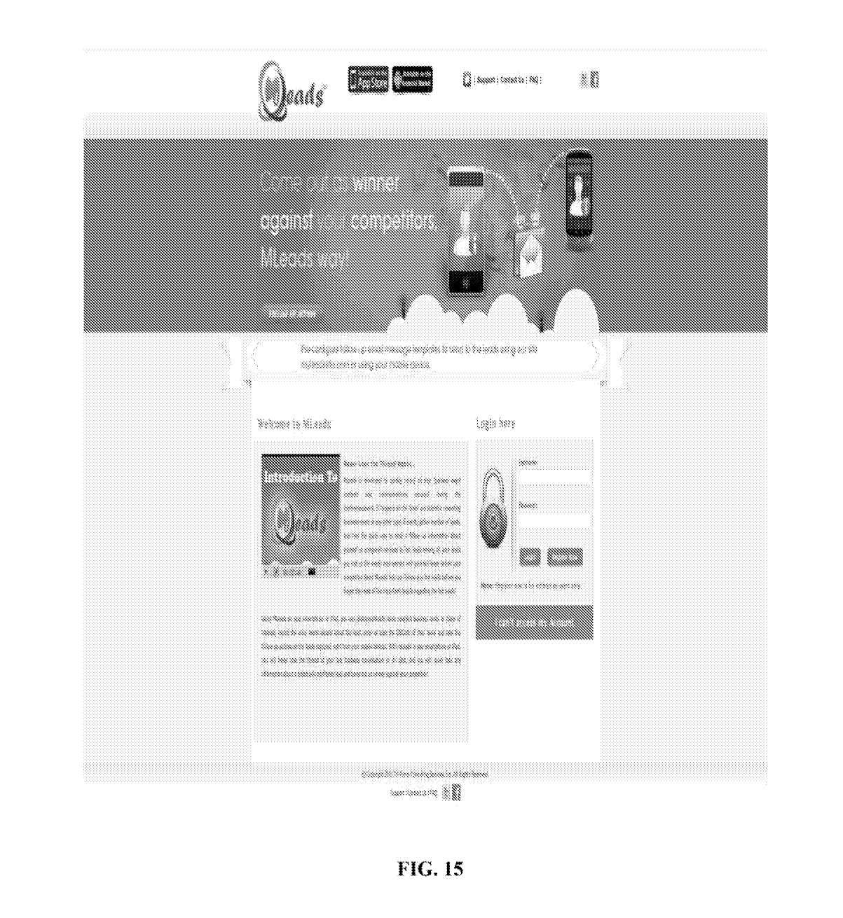

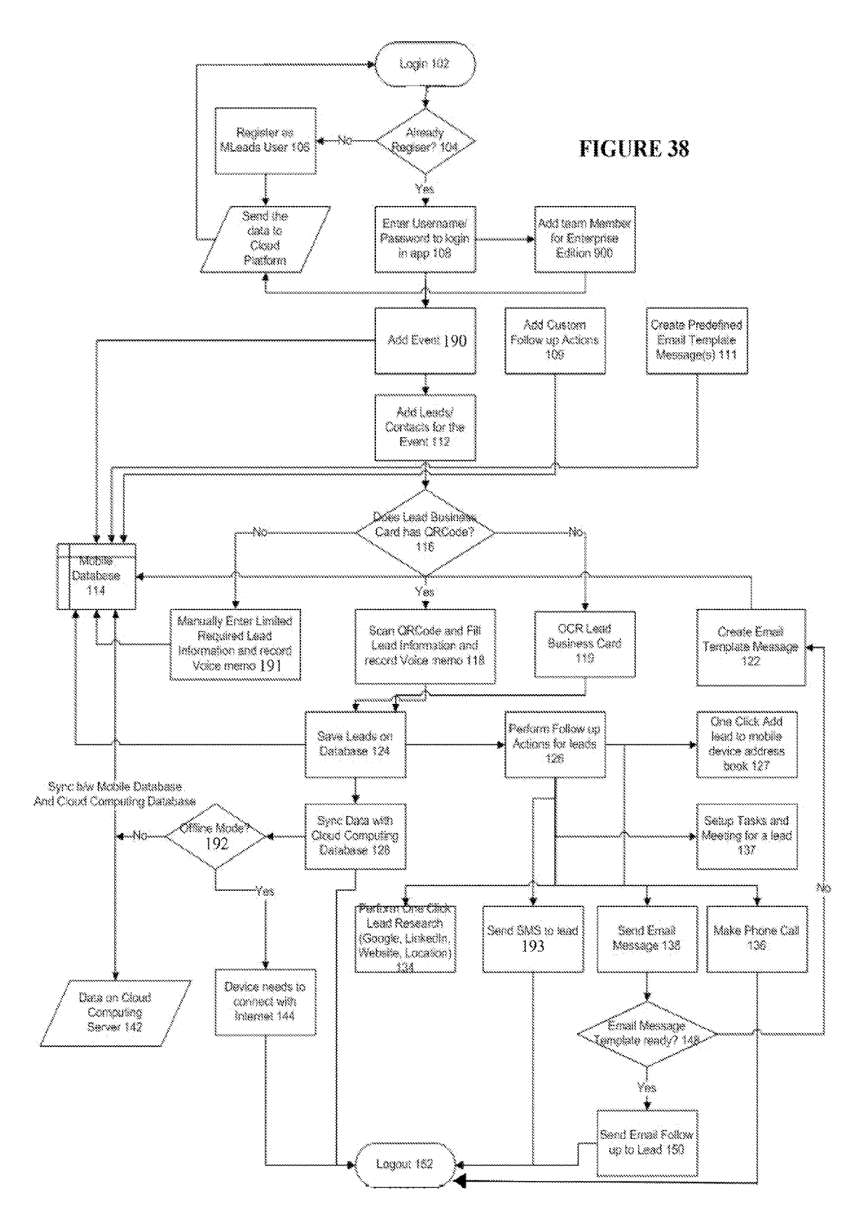

Referring now to FIG. 2, a flowchart of a method of following-up on business leads using the BLM system 1000 is exemplified. As mentioned above, the method of FIG. 2 is accomplished, by the BLM software which, in the exemplified embodiment, resides both on the mobile electronic device 700 and the BLM server 300. More specifically, a client portion of the BLM software resides on the mobile electronic device 700 that performs the functions described below that relate to the mobile electronic device 700. On the other hand, a centralized portion of the BLM Soli resides on the BLM server 300 that performs the functions described below that relate to the BLM server 300. In another embodiment, the entirety of the BLM software resides on the mobile electronic device 700, in another the entirety of the BLM software resides on the BLM server 300 where access to the functioning of the BLM software via the mobile electronic device 700 is accomplished, via a portal, such as a BLM website that is rendered using web browser software residing on the mobile electronic device 700. It should be noted that FIG. 2 is a simplified version of a user's interaction with the BLM software according to the present invention and, thus, does not discuss creating user accounts, logging-in and other features that are standard and not critical to the understanding of certain embodiments of the invention. These additional details will be described below with respect to FIG. 38 and the corresponding GUIs of FIGS. 15-37 and 39.

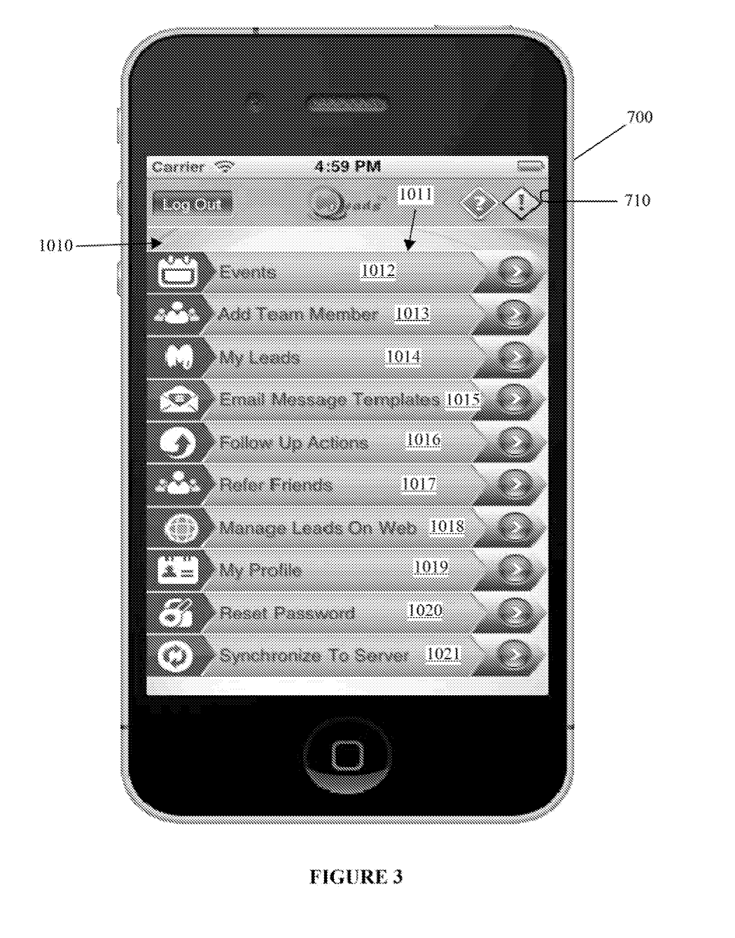

Once the BLM software (or the appropriate portion thereof) is downloaded and installed on the user's mobile electronic device 700, and the user 500 has an account setup in the BLM software, the user 500 can begin using the BLM software. Upon accessing and logging into the BLM software, the BLM software generates a management GUI 1010 (FIG. 3) that is presented in the display device 710 of the mobile electronic device 700. The management GUI 1010 includes a list 1011 of selectable category elements 1012-1021, which in the exemplified embodiment includes an events element 1012, an add team member element 1013, a business leads element 1014, a message template element 1015, a follow-up actions element 1016, a refer friends element 1017, a manage leads element 1018, a my profile element 1019, a reset password element 1020 and a synchronize with server element 1021. In the exemplified embodiment, the selectable elements 1012-1017 are in the graphical form of buttons. in other embodiments, and without limitation, a selectable “element,” as used throughout this application, can take the form of buttons, tabs, icons, links, or combinations thereof.

Upon the user 500 selecting and activating (which can be accomplished by simply touching or tapping the appropriate area if the display screen 710 is a touch screen) a desired on of the selectable elements 1012-1017, the BLM software will present, in the display device 710, the appropriate GUI that is next in the hierarchy. Selection and activation of each one of selectable elements 1012-1017 will cause the BLM software to present a different set of GUIs that relate to the functions of the BLM software that are available for the selected and activated one of the selectable elements 1012-1017. While the use of the BLM software will be discussed below in a specific order, it is to be understood that the user 500 can perform the actions discussed below in alternate order(s).

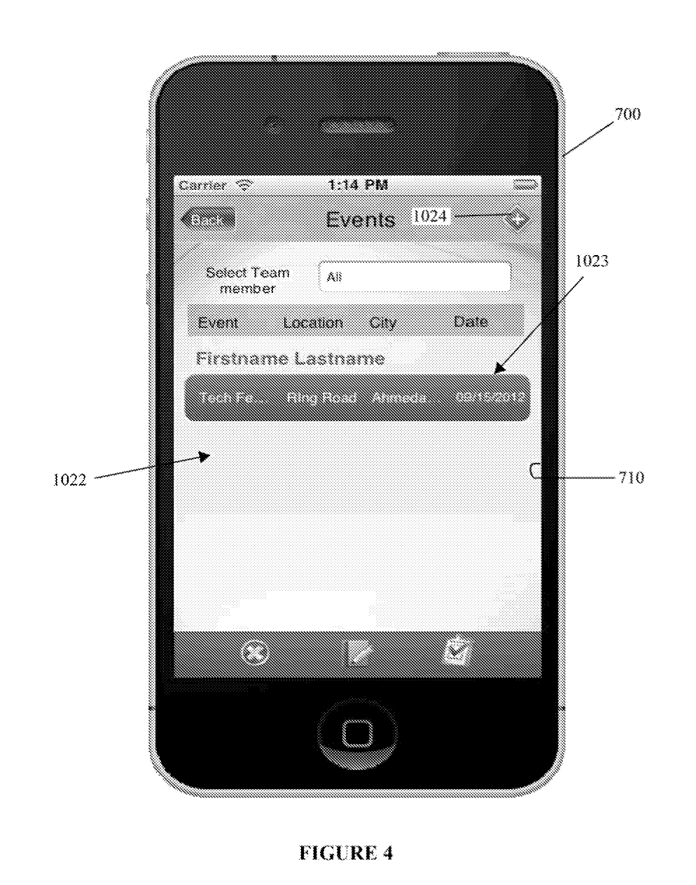

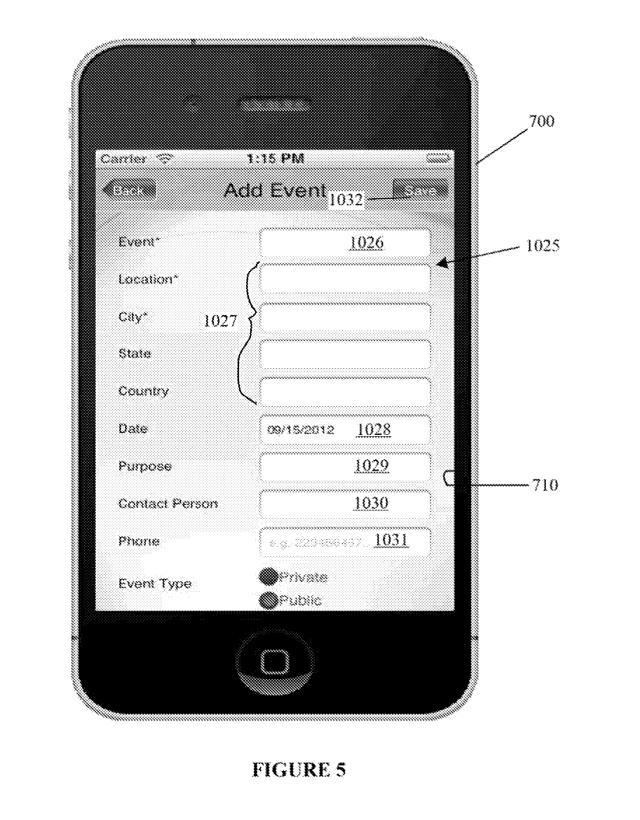

Beginning at step 110, the user 500 adds one or more events for which he/she desires to use the BLM software. During step 110, the user 500 selects and activates the events element 1012 that is presented in the display device 710 of the mobile electronic, device 700. Upon the events element 1012 being activated, the BLM software generates an events overview GUI 1022 which comprises a list of events 1023 that have been previously added by the user 500 (see FIG. 4). The events overview GUT 1022 is presented in the display device 710 by the BLM software. Each of the events in the list of events 23 is individually selectable for editing and/or further action as described below. The events overview GUI 1022 also comprises an add event element 1024, which is in the form of an icon. By selecting and activating the add event element 1024, the BML software generates and displays an add event GUI 1025 in the display device 710 of the mobile electronic device 700 (FIG. 5).

The add event GUI 1025 comprises a plurality of fields 1026-1031 in which the user 500 can enter information about the event that he/she is adding. In the exemplified embodiment, the add event GUI 1025 comprises an event name field 1026, event location fields 1027, an event date field 1028, an event purpose field 1029, an event contact person field 1030, and an event phone number field 1031. The user inputs the appropriate information into each of the fields 1026-1031 and, when finished, saves the inputted data for the subject event by selecting and activating the save event element 1032 in the add event GUI 1025.

Upon the user 500 selecting and activating the save event element 1032, the event information that was inputted by the user into the fields 1026-1031 is appropriately parsed and stored in an event database that is part of the BML database 750 as event data in the exemplified embodiment, the event data that is stored in the event database comprises event name data, event location data, event date data, event purpose data, event contact person data, and event phone number data. Of course, the event data can include more or less, or different types of event data than that which is exemplified above. Examples of events can include, without limitation, business meetings, social gatherings, tradeshows, and conferences.

Upon the event data being stored in the event database of the BML database 750, the stored event is associated with the user 500 that created the event. The event data may also be date and/or time stamped. The association of the event data to the user that created the event can be accomplished by the BLM software before, after or during the storage of the event data in the event database of the BML database 750. As discussed in greater detail below, the BLM database 350 of the BLM server 300 can include a user database in which data regarding all of the registered (or added) users within a business network is stored. The existence of a user database allows the associations between the various users and their captured and entered data to be used to evaluate the user's performance and estimate business's return on investment. Once the event is added by the user 500 as discussed above, the added event shows up in all GUI's generated by the BLM software in which a list of events for that user is displayed and is, thus, selectable for further action relating to that added event. The user 500 can add additional events as desired and at any time during the use of the BLM software.

Once one or more events are stored by the BLM software, the user 500 can then create pre-formed message templates that, as discussed below, will be used (in conjunction with other captured data) to expeditiously and automatically generate electronic messages that have a degree of personalization and business focus. At step 120, the user 500 uses the BLM software to create one or more pre-formed message templates. This is accomplished on the mobile electronic device 700 by the user 500 accessing the management GUI 1010 and selecting and activating the message template element 1015 (FIG. 3).

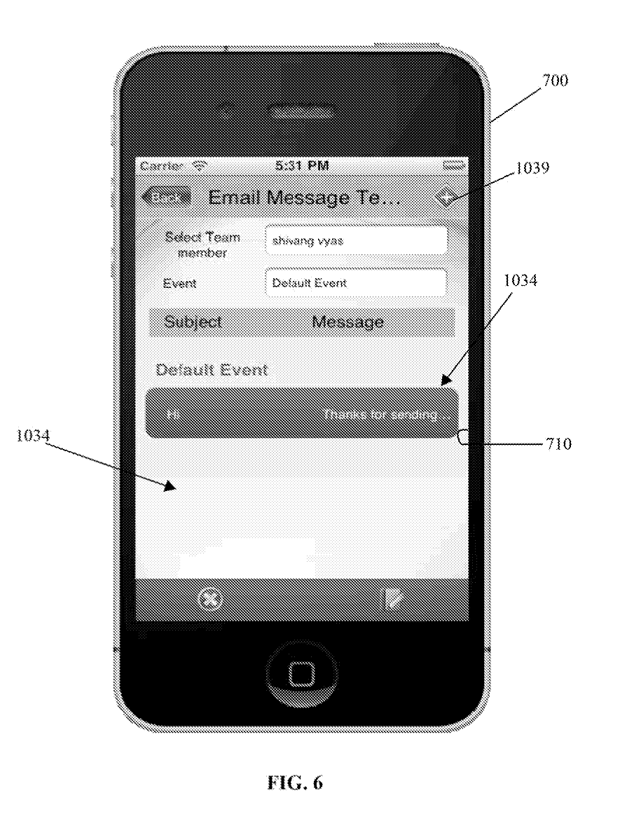

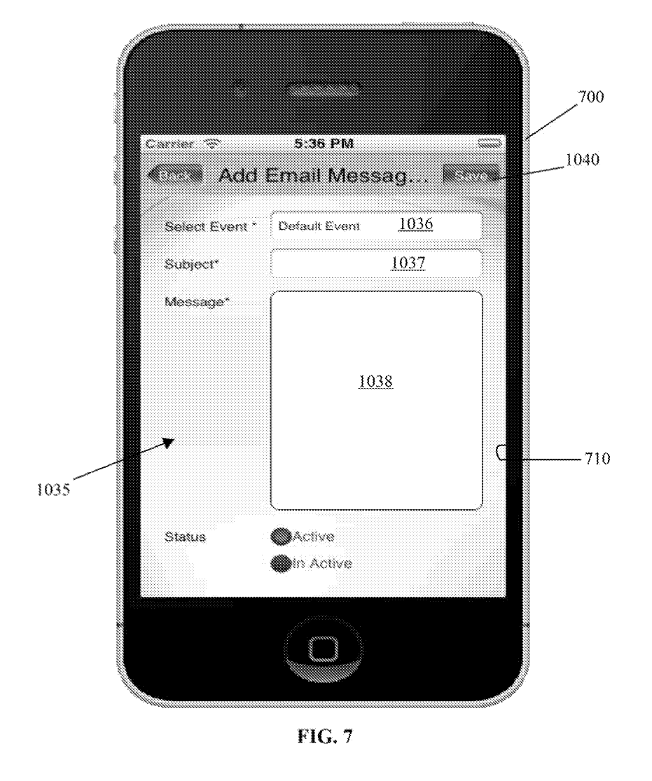

Upon selection and activation of the message template element 1015, the BLM software generates and displays in the display device 710 a message template overview GUI 1033 in which a list of re-formed message templates 1034 is displayed (FIG. 6). Each of the pre-formed messages in the list of pre-formed message templates 1034 is individually selectable for editing and/or further action as described below. The events overview GUI 1022 also comprises an add message template element 1034, which is in the form of an icon. By selecting and activating the add message template element 1039, the software generates and displays a create message template GUI 1035 in the display device 710 of the mobile electronic device 700 (FIG. 7).

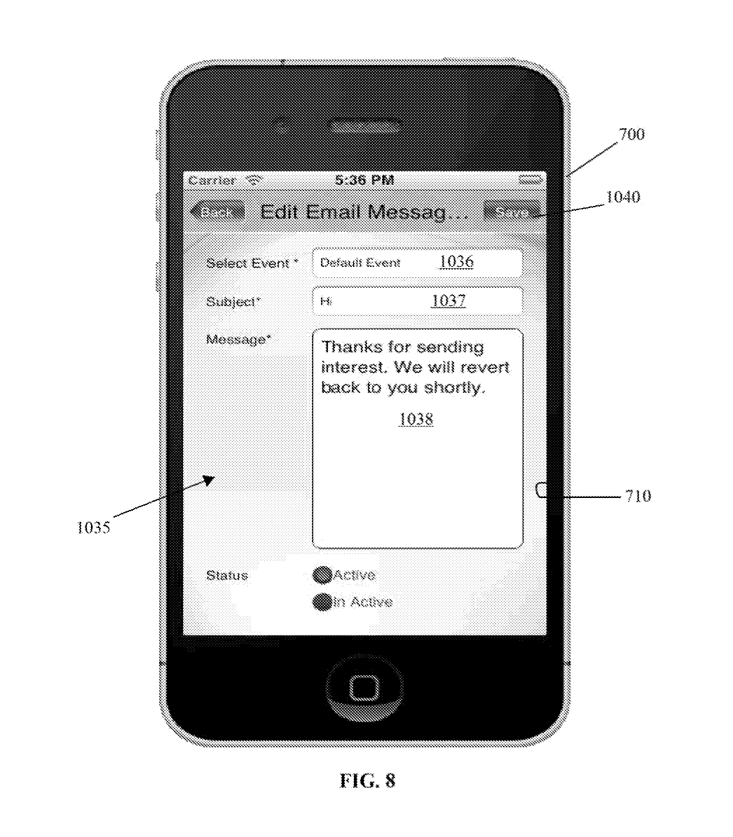

The create message template GUI 1035 comprises a plurality of fields 1036-1038 in which the user 500 can enter information to form the message template and to associate the message template that is being formed to an event. In other embodiments, it may not be necessary to associate the message template being formed with an event. In the exemplified embodiment, the create message template GUI 1035 comprises an event name field 1036, a subject field 1037, and a message body field 1038. The use inputs the appropriate information into each of the fields 1036-1038 and, when finished, saves the inputted data for the subject message template by selecting and activating the save message template element 1040 that is displayed in the create message template GUI 1035 (FIG. 8). For example, the user 500 can enter text into the message body field 1038 that he/she desires to be relayed to future business leads. The text can include information about the user's company, information about a product of the user's company, information about services of the user's company, and/or combinations thereof. Additionally, while not illustrated, a field may be provided in the create message template GUI 1035 that allows a file, such a brochure or service or product information document, to be automatically attached to an electronic message that is automatically generated by the BLM software based on the message template. being created. As will be discussed below, the message template being created may also comprise (either by being present in one of the fields 1036-1038 or by later addition by the BLM software) at least one substitute variable field that is automatically populated by the BLM software with a portion of captured business lead.

Upon the user 500 selecting and activating the save message template element 1040, the message template information that was inputted by the user into the fields 103-1038 is appropriately parsed and stored in a message template database that is part of the BML database 750 as message template data. Upon the message template data being stored in the message template database of the BML database 750, a pre-formed message template is created. The pre-formed message template may be date and/or time stamped, and may also be associated with the user whom created that pre-formed message template. The pre-formed message template may also be associated with an event that is stored in the event database of the BML database.

Once one or more pre-formed message templates are stored by the BLM software, the user 500 can then attend one or more of the stored events and capture business leads in an effective and efficient manner using the BLM software. At step 130, the user 500 uses the BLM software to capture business lead data relating to one or more business leads. This is accomplished on the mobile electronic device 700 by the user 500 accessing the management GUI 1010 and selecting and activating the business leads element 1014 (FIG. 3).

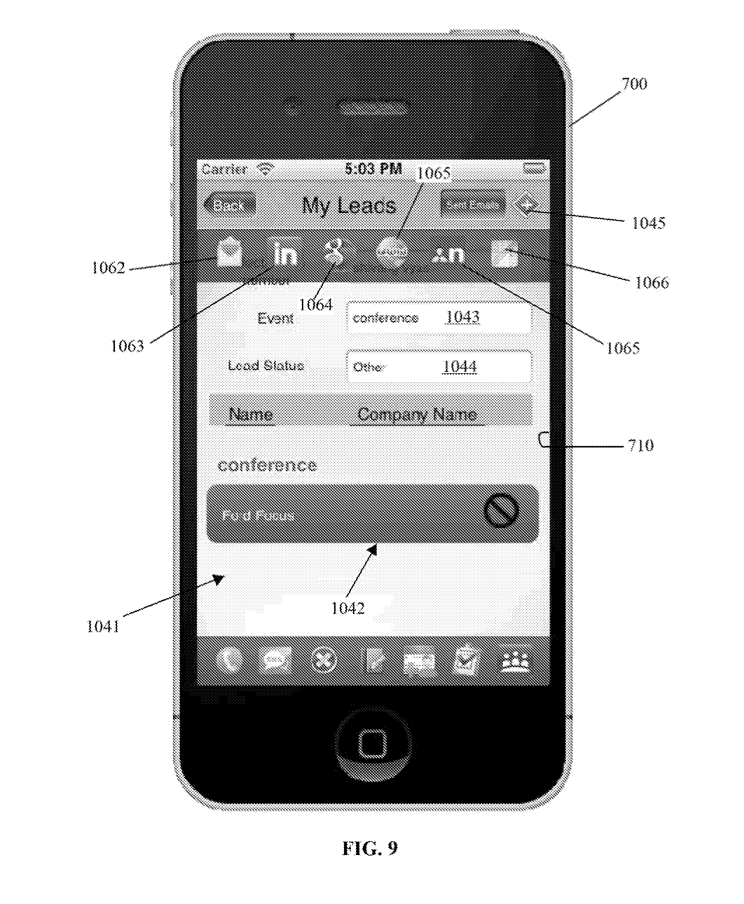

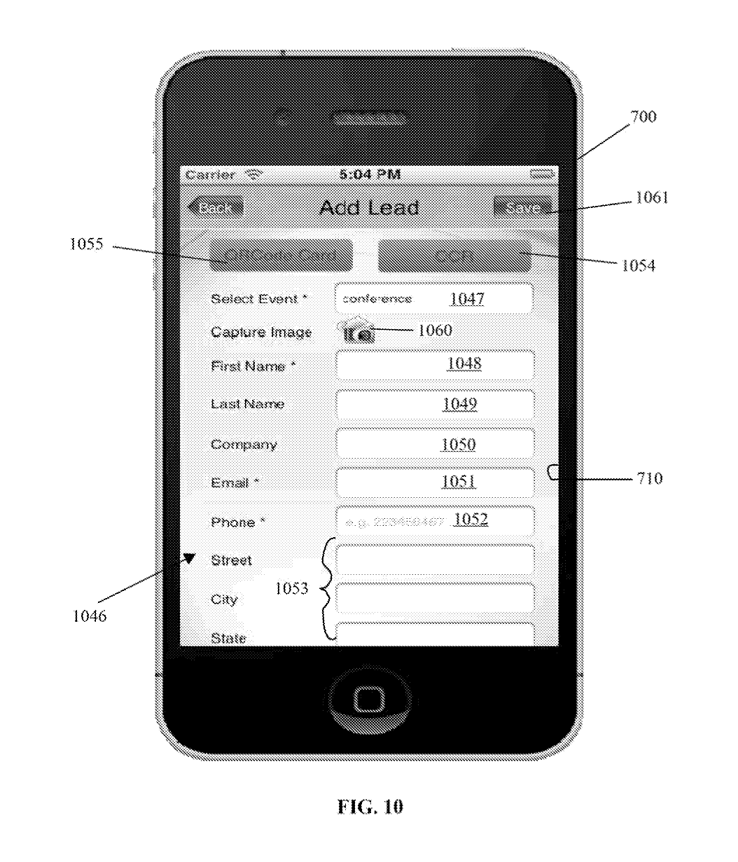

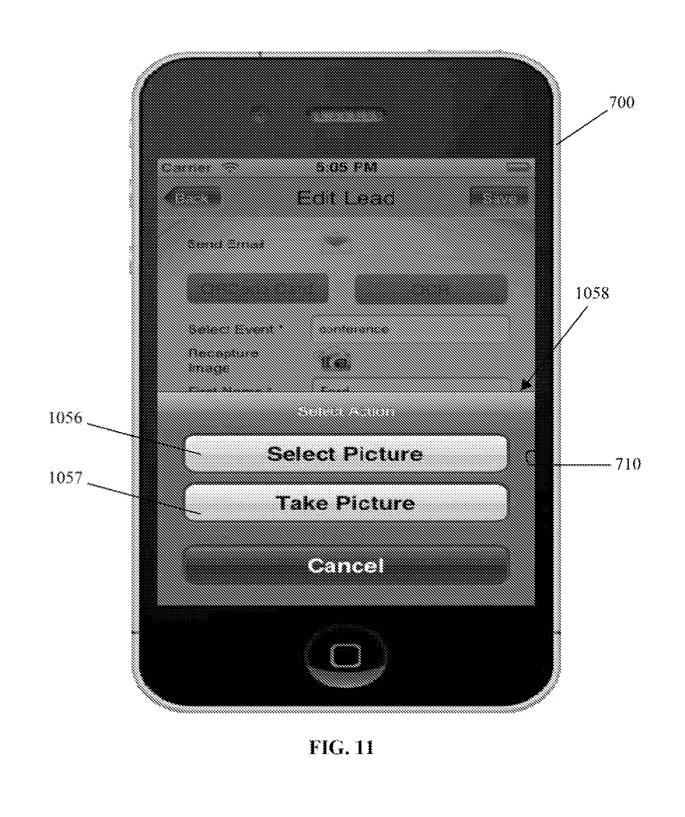

Upon selection and activation of the business leads element 1014, the BLM software generates and displays in the display device 710 a business lead overview GUI 1041 in which a list of business leads 1042 is displayed (FIG. 9). Each of the business leads in the list of business leads 1042 is individually (and collectively/concurrently) selectable for editing and/or further action as described below. The business leads overview GUI 1041 also comprises an event field 1043 and as lead status field 1044. The event field 1043 display's the event to which the business leads in the list of business leads 1042 are associated. The business leads overview GUI 1041 also comprises an add business lead element 1045, which is in the form of an icon. By selecting and activating the add business lead element 1045, the BML software generates and displays an add business lead GUI 1046 in the display device 710 of the mobile electronic device 700 (FIG. 10).

The add business lead template GUI 1046 comprises a plurality of fields 1047-1053 in which the user 500 can capture business lead information that is ultimately stored in the business lead database as business lead data. In the exemplified embodiment, the add business lead GUI 1035 comprises an event name field 1047, a first name field 1049, and a last name field 1049, a company name field 1050, an email address field 1051, a phone number field 152, and a company address field 1053. The event name field 1047 identifies the event stored by the BML software to which the business lead being generated is to be associated. The fields 1048-1053 are for receiving information necessary to create a new business lead.

The appropriate business lead information which, for example can be contained on a business card, can be captured into the fields 1048-1053 in a variety of manners in accordance with the present invention. In one embodiment, the user can manually populate the fields 1048-1053 using the keyboard of the mobile electronic device 700 based on a visual inspection of the business card.

In another embodiment, the user 500 can utilize optical character recognition (“OCR”) technology to populate the fields 1048-1053 with business lead data that is present in a relevant image, such as an image of a business card. Under this capturing technique, the user 500 selects and activates the OCR element 1054. As a result of the OCR element 1054 being activated, the BLM software generates an overlay 1058 in which the user 500 can choose whether to: (1) activate a take picture element 1057; or (2) activate a select picture element 1056. If the user 500 has a new business card which he/she wants to extract the business lead data from the user 500 selects and activates the take picture element 1057. Upon the take picture element 1057 being activated, the BLM software interfaces with the camera software residing on the mobile electronic device 700 to launch the camera software. The user then takes a picture of the business card (which is stored in the memory of the mobile electronic device 700) as an image file. Once the image of the business card is captured, the BLM software automatically performs an optical character recognition process to the captured image to extract business lead data therefrom, automatically parses the extracted business lead data, and automatically populates the appropriate fields 1048-1053 with the business lead data. Alternatively, if previously obtained images of business cards are stored in the memory of the mobile electronic device 700, the user 500 can activate the select picture element 1056 in the overlay 1058. In this situation, the BLM software will access the folder in which the images are stored and allow the user 500 to select one of the previously stored images. Upon the user selecting one of the previously stored images of a business card, the BLM software automatically performs an optical character recognition process to the selected image to extract business lead data therefrom, automatically parses the extracted business lead data, and automatically populates the appropriate fields 1048-1053 with the business lead data. While the OCR technique is described above as being utilized in conjunction with a business card image, images of other documents and objects can be utilized with the OCR capabilities of BLM software.

In yet another embodiment of business lead data capture, the user 500 can utilize matrix bar code scanning to capture business lead data from a business card or other document or object. If the bus mess card (or other object) comprises a matrix bar code, such as a Quick Response Code® (“QRcode”), the user can select and activate the QRCode element 1055 in the add business lead GUI 1046. Activation of the QRCode element 1055 results in the BLM software executing code necessary so that camera of the mobile electronic device 700 will function as a matrix bar code scanner. The user 500 then positions the camera adjacent to the matrix bar code of the business card. The camera scans the matrix bar code, thereby resulting in the BLM software automatically extracting and automatically parsing the business lead data encoded therein, and automatically populating the appropriate fields 1048-1053 with the business lead data.

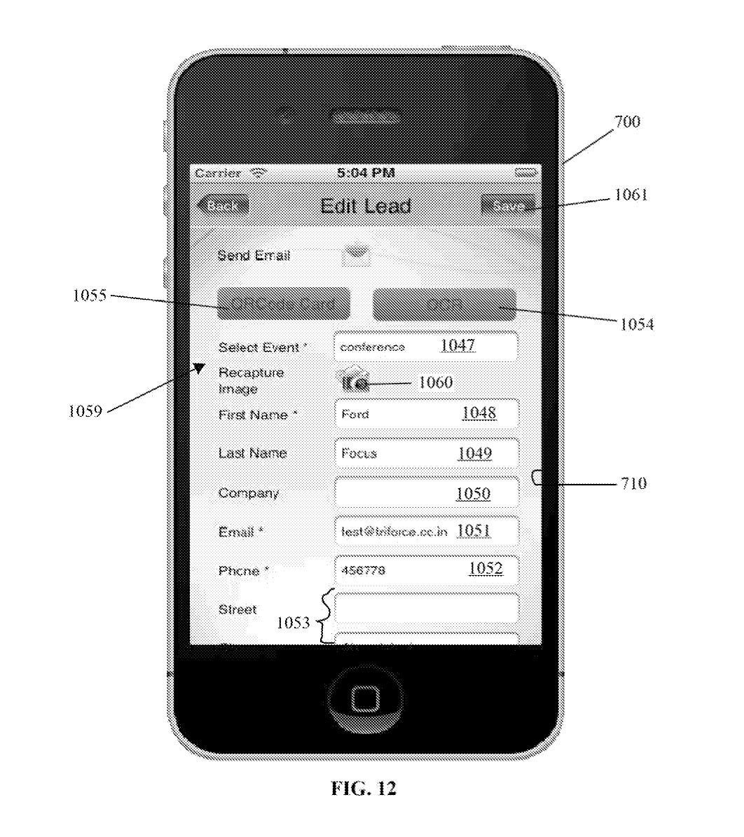

Once the OCR process or QRCode process is complete and the BLM software has automatically populated the fields 1048-1053 with the extracted business lead data, an edit business lead GUI 1059 is presented in the display device 710 (FIG. 12). This allows the user to confirm the accuracy of the business lead data in the fields 1048-1053 and to make any corrections necessary.

Additionally, in the add business lead GUT 1046, a capture image element 1060 is provided. The capture image element 1060, when activated, results in the BLM software interfacing with and launching the camera software stored on of the mobile electronic device 700. The user can then take a picture with the camera, which is automatically associated with and included as part of the business lead data that is stored in the business lead database. Similarly, an audio element can be included that, when activated, allows the user to record an audio message which is saved as an audio file that is automatically associated with and included as part of the business lead data that is stored in the business lead database.

The edit business lead GUI 1059 and the add business lead GUI 1046 both comprise a save business lead element 1061. Upon the user 500 selecting and activating the save business lead element 106, the business lead information that was captured in fields 10148-1053 is appropriately parsed and stored in a business lead database that is part of the BML database 750 as business lead data. In the exemplified embodiment, the business lead data that is stored in the business lead database comprises name data, company data, delivery data, user notes regarding the business lead, and combinations thereof.

In certain embodiments, the BLM software automatically associates the business lead data that is stored in the business lead database 750 with an event (or event data in the event database) and/or the user whom captured the business lead.

Once one or more business leads are captured, all of the captured business leads are displayed in the business lead overview GUI 1041 (FIG. 9). As mentioned above, each of the business leads in the list of business leads 1042 is selectable by the user. At this stage, the user 500 performs step 104 in the following manner so that the BLM software automatically generates electronic messages based on (1) the business lead data that is stored in the business lead database for the selected business lead; and (2) a selected one of the pre-formed message templates in the message template database.

In performing step 140, the user 500 first selects one for a plurality) of the business leads from the list of business leads 1042. The user then activates the generate electronic message element 1062 which is displayed in the business lead overview GUI 1041. Upon the generate electronic message element 1062, the BLM software then presents the user with an interface, such as the message template overview GUI 1033 of IFG. 6, in which a list of pre-formed message templates 1034 is displayed. The user then selects (and activiates if necessary) one of the pre-formed message templates form the list. As a result, the BLM software automatically generates an electronic message (which can be in the form of an email or an SMS text message) by: (1) retrieving, from the business lead database, the business lead data for the selected business lead; (2) retrieving, from the message template database, the selected pre-formed message template; (3) automatically populating certain fields of the selected pre-formed message template with retrieved business lead data of the selected business lead; and (4) automatically populating fields of the electronic message with retrieved business lead data of the selected business lead. For example, in an embodiment where the selected pre-formed message template comprises a substitute variable field, such as in the salutation field, the BLM software will automatically populate the substitute variable field with the name data of the business lead data of the selected business lead. Moreover, the BLM software will also automatically populate the delivery address field of the electronic message with the delivery data (such as an email address or cell phone number) for the selected business lead.

In certain embodiments, a plurality of the business leads of the list of business leads 1042 can selected concurrently. In such an embodiment, after one of one of the pre-formed message templates is selected from the list of pre-formed message templates, the BLM software will automatically generate a single electronic message to be sent to delivery addresses of all of the selected business leads using the selected pre-formed message template.

In generating the electronic message, the BLM software will interface with electronic message software (such as Outlook, a pop email server, or other email app) residing on the mobile electronic device 700 for other computer apparatus) to generate a blank electronic message. The BLM software will then automatically populate fields of the blank electronic message with the business lead data for the selected business lead and the selected one of the pre-formed message templates to form the electronic message.

Where necessary, the BLM software will also populate certain fields of the electronic message with user data retrieved form the user databse. For example, the BLM software may populate the “from” field of the electronic message with the user's email address. Additionally, the BLM software may populate the signature hue of the body of the electronic message with the user's name and contact information. Once the emails are generated, the BLM software may either automatically send the electronic message or display the electronic messages for user review and manual send.

In another embodiment, instead of or in addition to performing, step 140, the user may also perform step 150, in which the BLM retrieves and uses business lead data for a selected business lead to obtain additional information on the selected business lead from secondary sources of information. This step 150 can be accomplished by selecting the desired business lead from the list of business leads 1042 in the business lead overview GUI 1041 and activating a desired one of the appropriate secondary source of information elements 1063-1066. For example, activating secondary source of information element 1063 will cause the BLM software to automatically retrieve business lead data at the selected business lead from the business lead database, export this retrieved data to a search field of a professional profile website (such as LinkedIn®), execute the search on the professional profile website, and display the search results in an interface. The interface can be a separate web browser, a window formed in one of the BLM software GUIS, or an integrated API. Using the secondary source of information element 1064, a similar search of the internet can be performed by the BLM software by exporting the retrieved business lead data into the search fields of a web page of an internet search engine (such as Google®). Using the secondary source of information element 1066, a similar search tor location and/or directions can be performed by the BLM software by exporting the retrieved business lead data into the search fields of a web page of a map based search engine (such as Google Maps®). Using the secondary source of information element 1065, a website of the company related to the business lead can be directly accessed by the BLM software retrieving the domain name from the email address of the stored business lead data and exporting it into the address bar of a web browser. Thus, the BLM software can provide a wide variety of additional information on a selected business lead with only one-click by the user 500.

Referring now to FIG. 38, a detailed flowchart of the method of using the BLM software is illustrated according to an embodiment of the present invention. The BLM software (or use thereof) may include a step 102 of a user logging in to the BLM software which may be named, for example, a “MLeads” application. A step 104 may include deciding if the user is already registered. A step 106 may include registering a user as a registered user of the BLM software. A step 108 may include entering a username and password to log in to the BIM software. A step 900 may include creating a team member username and password for which the data gets sent to the BLM server, which may include a centralized portion of the BLM software (collectively which can be considered a cloud platform). A step 109 may include adding follow up actions for business leads. A step 190 may include adding an event including information about the event into the BLM software. Information about the event may include, for example, business and personal contacts and communications occurred during conferences or events attended, that may be stored on a mobile device or computer device. A step 111 may include creating pre-formed message template(s) for the events. A step 112 may include adding business leads for the event. Business leads may include business opportunities discovered, at the conferences. Business leads may be captured on the mobile device 700 during the conferences. For example, a picture of a business card may be taken, or the business card with a quick response code (QRCode) may be scanned. The business lead may also be entered manually. A user may voice record important details about the business lead. A step 114 may include adding the event 110 to a mobile database. A step 116 may include checking if a business card has a QRCode. If so, a step 118 may include scanning the QRCode and filling in lead information and recording a voice memo. If the business card does not have a QRCode, a step 119 may include OCR the business card of the lead and filling in the lead information and recording a voice memo or a step 191 may include filling in lead information and recording a voice memo. A step 124 may include exporting and saving the business leads in the mobile database 114.

In an exemplary embodiment, a step 126 may include follow up action. As an example, follow up emails may be pre-configured message templates for sending to business. leads acquired at a business conference. A step 128 may include synching data with a cloud computing database. A step 192 may include checking if the mobile device is in offline mode. if so, a step 144 may include checking, if the device needs to connect with the interact. If the mobile device is not in offline mode, a step 142 may include synching between the mobile database and a cloud computer database, on the cloud computing server. As an example, a user may access data twenty-four hours a day, seven days a week from the cloud computing server by means of an internet browser using a computer apparatus 200 (FIG. 1.) A step 132 may include deciding whether to create a custom follow-up message following the step 126 of follow-up action. If so, a step 134 may include creating custom follow-up action. A step 146 may include implementing the custom follow up action. If the step 132 of deciding whether to create a follow-up message is no, a step 136 may include a phone call follow up action, or a step 138 of an email follow up action, or a step 140 of sending a text message such as a short message service (SMS) follow up action. After the step 138 of an email follow up action, a step 148 may include deciding if an email message template is ready. If so, a step 150 may include sending an email follow up to a business lead using the pre-formed message template. If the email message template is not ready, a step 122 may include creating an email message template. The leads data may be exported for later import into a mobile or computer system. A final step 152 may include logging out from the BLM software. A step 134 Background searches may be done on the leads. A step 137 tasks or meeting, invite can be setup for a lead

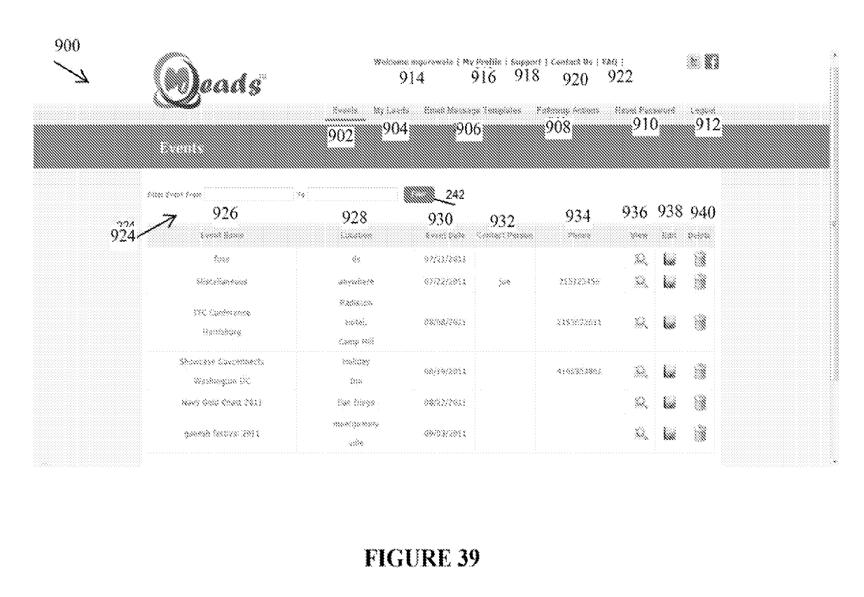

FIG. 39 show a front view of an event description screen 900 according to an exemplary embodiment of the invention. Other screens that may he selected include the Events Description Screen 902 (shown in FIG. 39), MyLeads 904 to display the user's leads, Email Message Templates 906, which displays sample email templates, Followup Actions 908 which displays planned follow-up actions on the user's leads. Reset Password 910 which allows the user to reset a password, and Logout 912 which allows the user to logout. The event description screen 900 may include a button 902 for adding an event. Further selectable screens may include a welcome screen 914 that displays general information, My Profile screen 916 which allows the user to change the user's profile, Support screen 918 which shows customer support contact information, Contact Us screen 920 which gives general company contact information, and FAQ screen 922 which gives answers to frequently asked questions The user may select a date range 924 and press a filter 942 button to display events for the input data range 924. Event information may include an event name 926, location 928, event date 930, contact person 932, and Phone 934. The user may select view 936 to view the event, select edit 938 to edit the event, and select delete 940 to delete the event.

In an exemplary embodiment users may send LinkedIn® connect request to the lead; perform a LinkedIn® profile search on the lead, perform a Google® Search using the lead's first name, last name or company name; launch the company website in a browser for the lead using the domain name portion of the email address of a lead, and add the lead into a mobile device address book.

The BLM software supports the ability to instantaneously manage and perform follow ups to business leads gathered during tradeshows or any networking events without any dependence on support staff to any individual who is responsible for sales or marketing efforts of an organization. Another advantage of the BLM software is that allows businesses to increase and valuate their return on investment (ROI) of the sales/marketing efforts of any organization or sales user in the world. The BLM software allows a user to use his/her iPhone or iPad or Android or Blackberry devices to (1) quickly record all your business or personal contacts and communications; (2) immediately send a customized follow up about you and your company's services using predefined follow up email message templates; (3) manage tasks for events and business leads; (4) manage meetings based on business leads; (4) send preconfigured email messages to all collected leads at once; (5) helps users you to follow-up on his/her business leads before he/she forget the most important communication details he/she had with the business leads.

In certain embodiments, the BLM software captures and performs follow up actions on business leads on a mobile electronic device anywhere. No typing is necessary in certain embodiments where QRCode and OCR scanning capability eliminates data entry. Captured business leads can be managed using secure cloud computing platform. The BLM software can automatically export business leads in .xls format by using on-line portal, from which that date can be imported into any system from the exported excel file. The BLM software also makes it possible to one-click look-up a professional profile of the business lead is disucssed above. The BLM software also makes it possible to one-click to send an affiliation request to a business lead (such as a contact request or a friend request in a social network site). The BLM software also makes it possible to one-click perform a web search on the business lead lead, The BLM software also makes it possible to one-click launch the business lead's company website for company research. The BLM software also makes it possible to one-click add business lead contact details to mobile device address book etc.

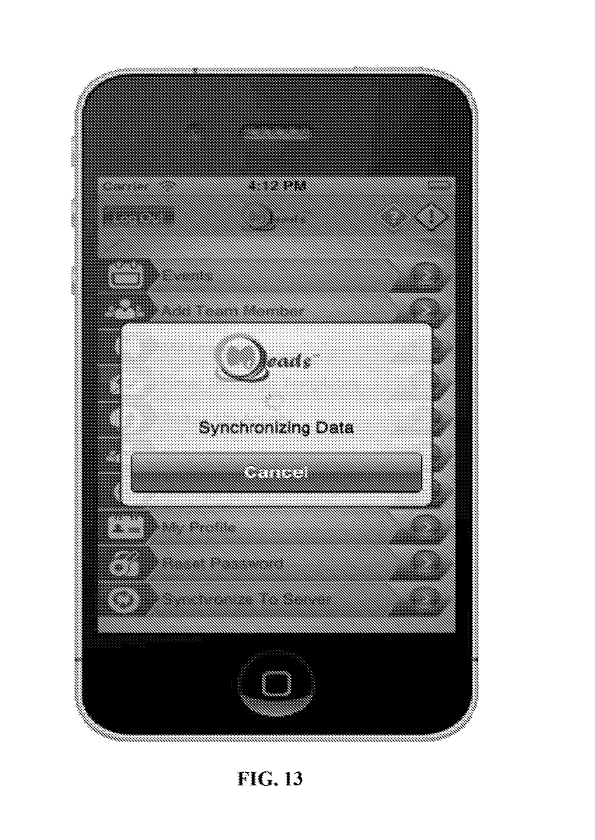

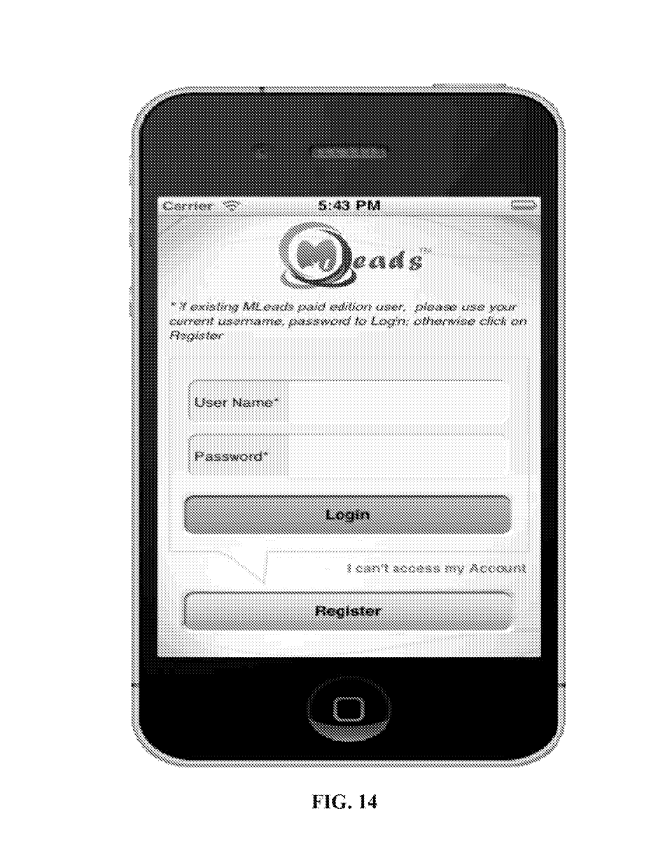

The BLM software also allows the user makes it possible to manage completed action items and to sorting business leads by name or company name. The BLM software also provides an interface by which the user can refer the BLM software to friends or their business leads. The BLM software also allows data synchronization between the BLM database 750 on the mobile electronic device 700 and the BLM database 350 on the remote server (FIG. 13).

An Internet connection is not required to use BLM software at the end users location. As discussed above, the BLM software is connected to a locally established database 750 installed on the mobile device 700. The user will enter the user name and password, and begin using the BLM software. The user names and passwords will be assigned and managed at the remote server 300 using the database 350, which, as mentioned above, is synced with the database 750.

Once an Internet connection is available on the user's mobile device, data can be synchronized to and from the MLeads cloud computing platform using an internet connection in an encrypted format.

Regarding task management, the BLM software allows: (1) users can schedule a new task for selected Event and selected Lead: (2) users can view scheduled tasks for selected events or selected business leads; (3) users can edit/modify scheduled task; and (4) users can cancel scheduled tasks.

The BLM software also allows management personnel to monitor leads captured by their sales/marketing, team members or employees from the company. This is a very useful feature for any business or an organization to improve Return on Investment on marketing/sales efforts across company wide sales/marketing force

The BLM software also allows: (1) the user to create unlimited predefined email message templates to use later on for doing instant follow up from the mobile device using an application; (2) the user to send preconfigured email to all collected leads for a selected Event at once; and (3) the user to record voice memo for a discussion with lead to review later

Users can also access the data captured using the mobile devices 100 on the computer apparatus 200 over the internet connection by going to the cloud computing platform website using the internet browser. Users can access the data on is secure encrypted protocol by entering the same username and password that gets used on the mobile device. Once authenticated successfully with the username/password, user can access the data and perform all the major functions on the leads data that they would normally do on a mobile device.

Referring now to FIG. 15, a homepage of the website generated by the BLM software is illustrated. The homepage provides information about the BLM software. The homepage includes a Login Here section with a region for a user to type in a username and a password. Thus, a user can register for the application and login (if previously registered) through the homepage. Furthermore, a user can recover his or her user name and/or password by clicking on the “I can't access my Account” button. Furthermore, a user can be redirected to the mLeads Apple and Google stores to download the application by clicking on the icon on the top of the homepage.

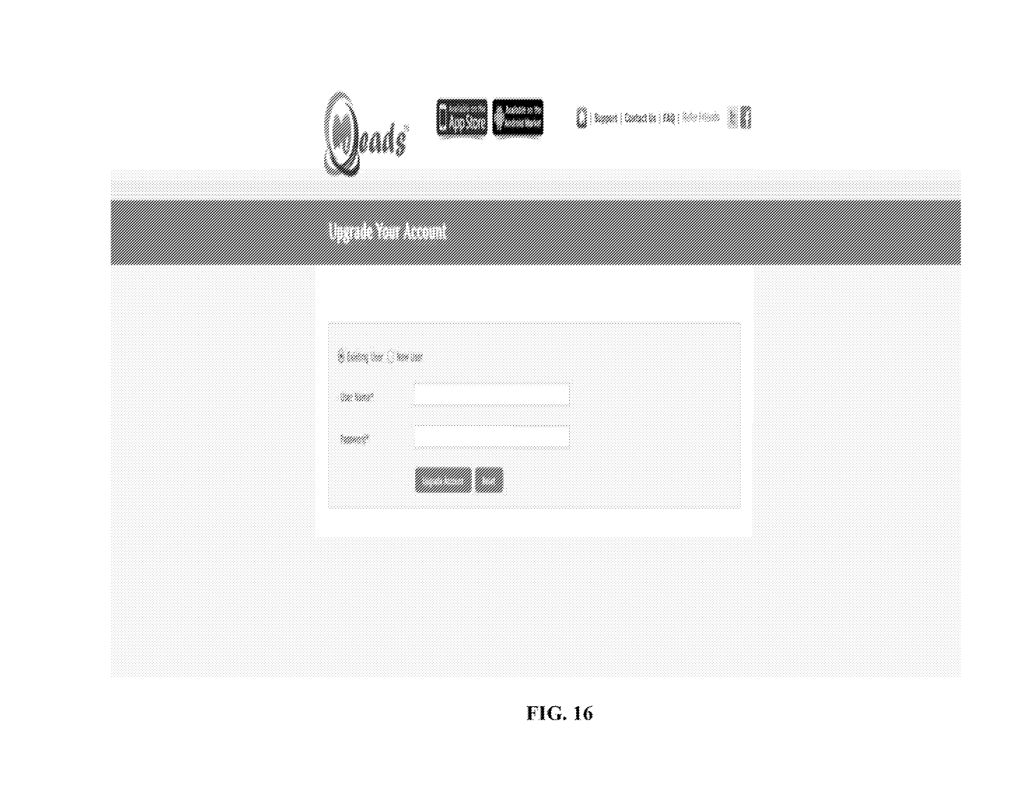

FIG. 16 illustrates the registration page of the website generated by the BLM software. Upon to user clicking on “Register Now” on the homepage, the BLM software will prompt a user to select whether he or she is an “'Existing User” or a “New User.” If the user is an existing user, then the user will be prompted to enter his or her username and password to upgrade the existing business account. The functionality of the registration page is used for a business user who can upgrade the account directly, by extending his or her account for the BLM software.

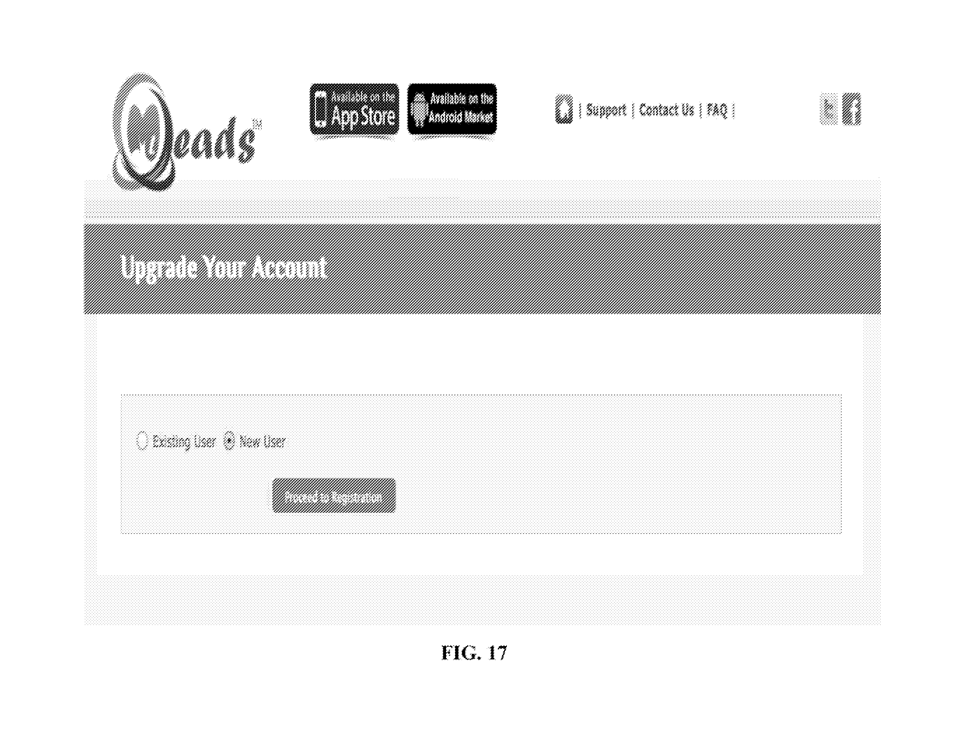

FIG. 17 illustrates an upgrade your account page of the website generated by the BLM software. If a user selects “New User,” the website will redirect the user to the registration page upon the user clicking on the “Proceed to Registration” button.

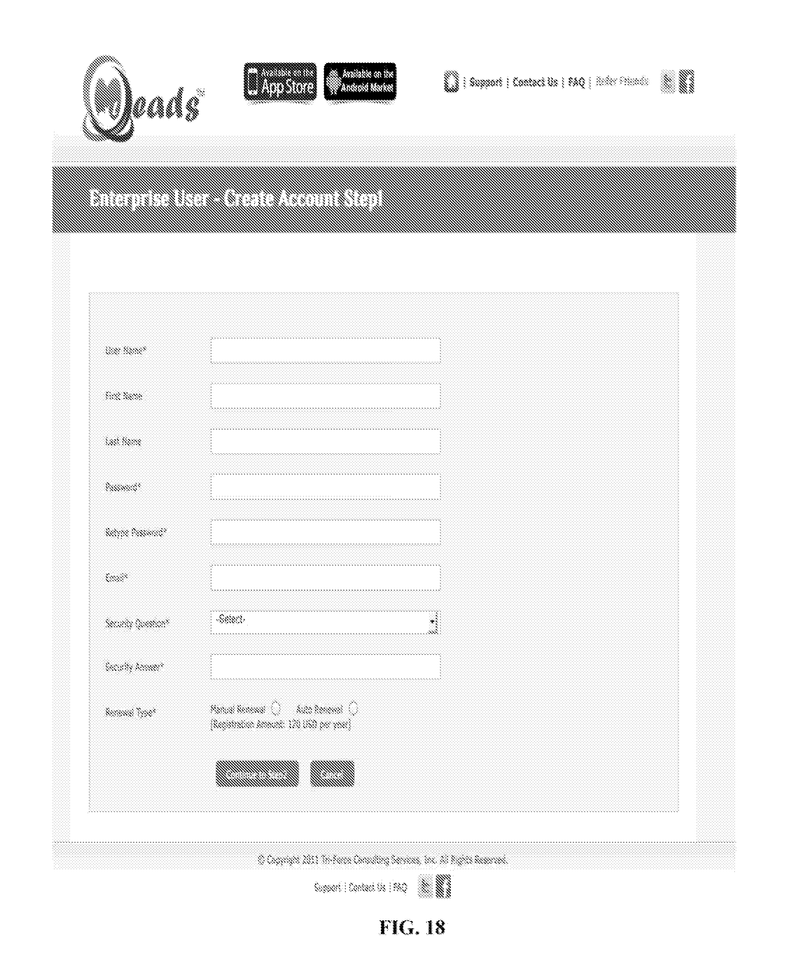

FIG. 18 illustrates the Enterprise. User—Create Account Setup page of the website. This page prompts the user to provide information including: user name, first and last name, password, email address, security question, security answer and renewal type. The user can select manual or auto renewal option for BLM software payment. If the user selects manual renewal, then the system will inform the user regarding expiry of account. For auto renewal, the funds will be automatically and directly deducted from the user's account.

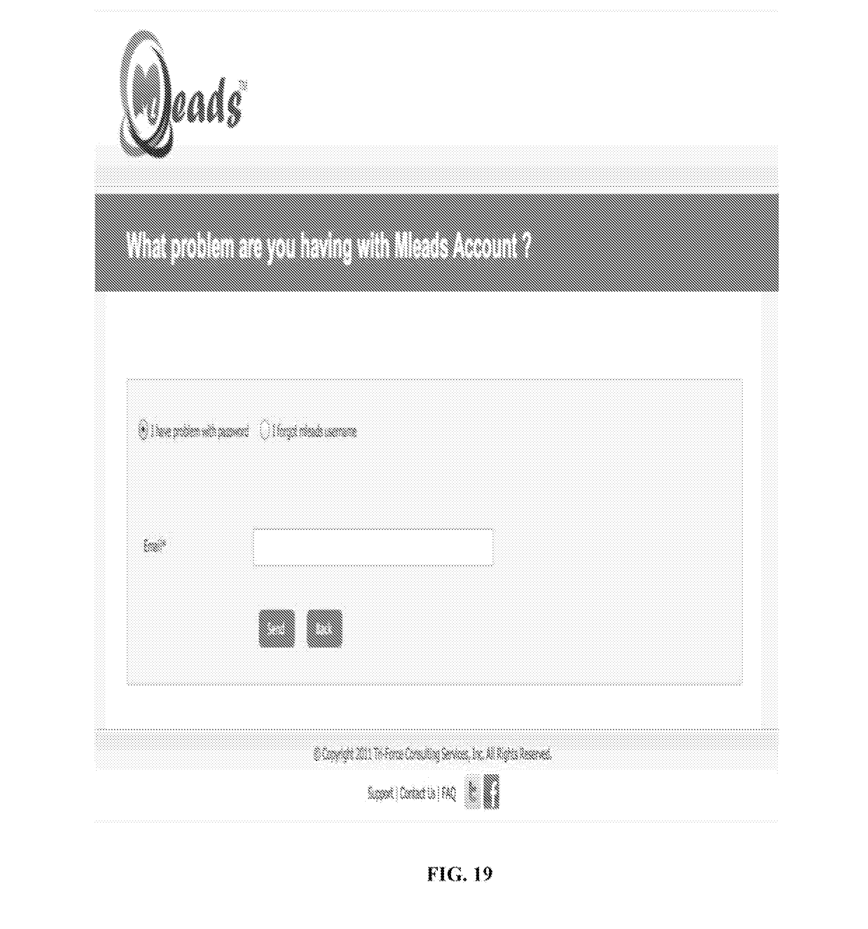

FIG. 19 illustrates the “Can't Access Account” page of the website generated by the BLM software. If a user has a problem while accessing his or her account, then the user can recover his or her username or password on this page by providing the user's email address.

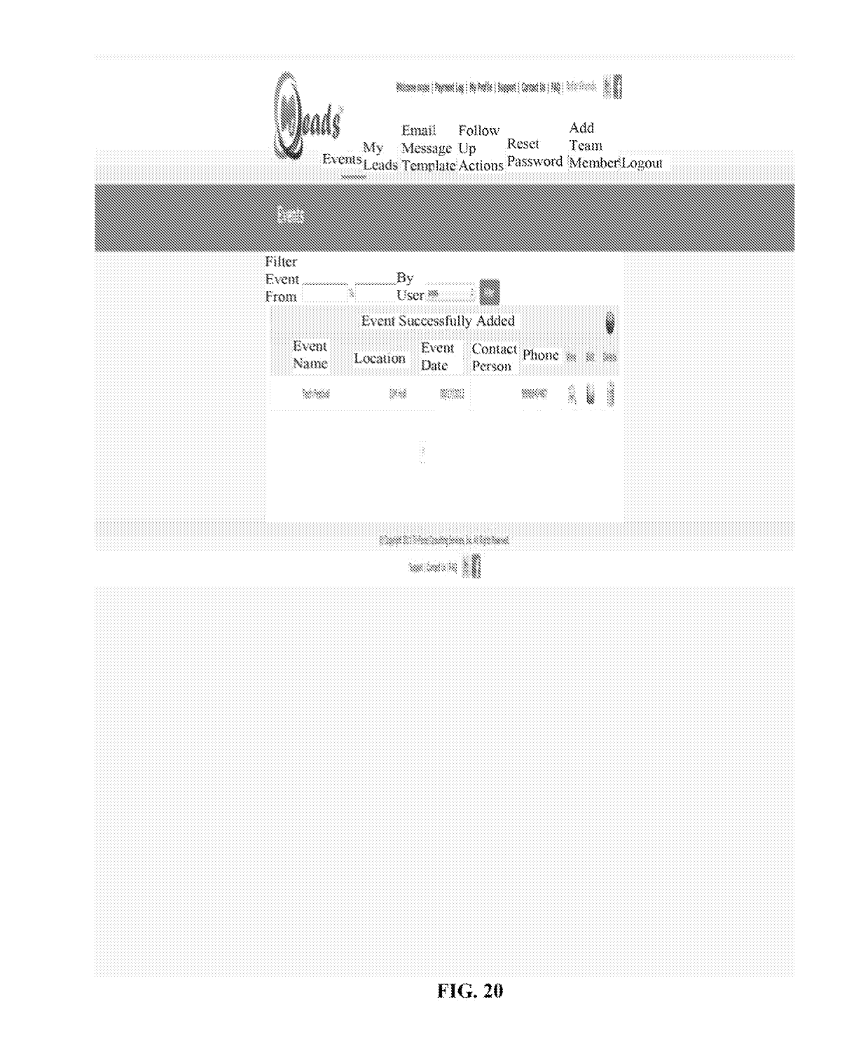

FIG. 20 illustrates the events page of the website generated by the BLM software. On this screen the user can see a list of events in descending order of the events date. Each row of records will display the event name, location, event, date, contact person, and phone number. The user can perform view, edit and delete actions for each particular event. By clicking on the “+” icon at the top right of the Events page, the user can add a new event. As the user clicks on the delete icon, a dialog box will appear to confirm that the user is certain that he or she wants to delete that record. The user can filter events by specifying the event date periods and by selecting a team member.

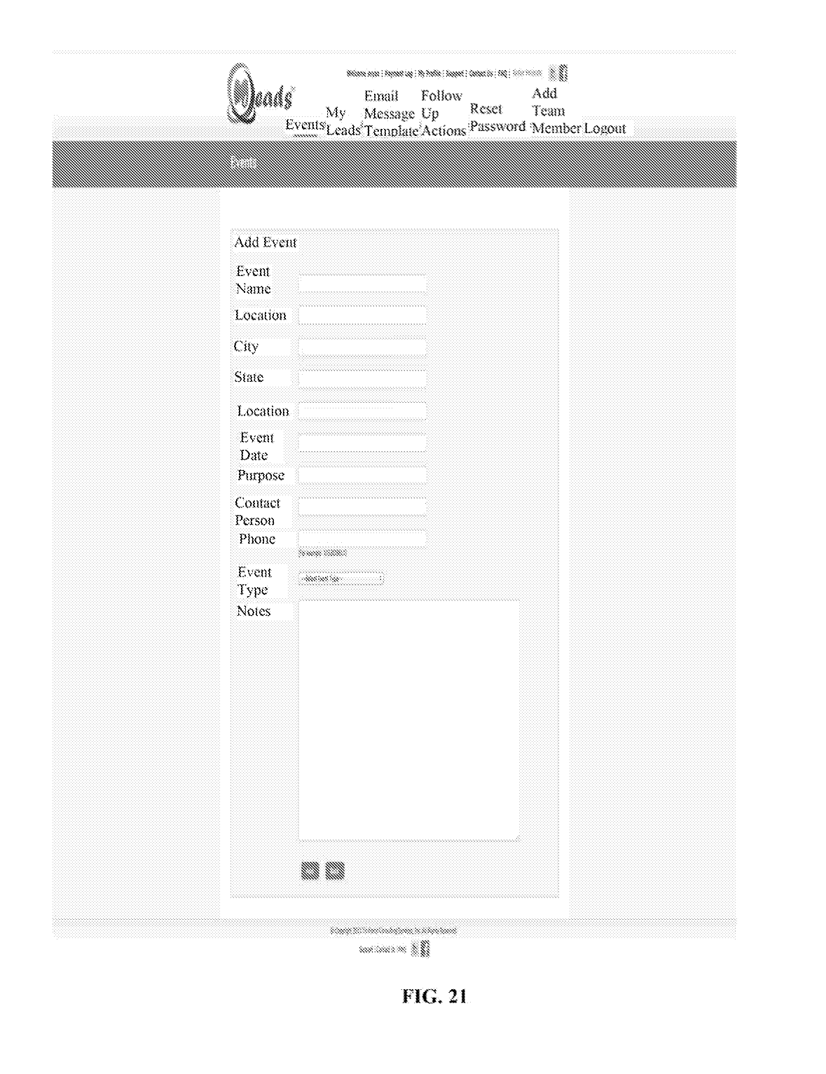

FIG. 21 illustrates the Add Event page of the website generated by the BLM software. When the user clicks on the “+” icon on the Events page as discussed above. the application/website will be redirected to the Add Event page, On this page, the user can add an event by filling in all of the required details related to the event (i.e., event name, location, city, state, date, purpose, contact person, phone number, event type and additional notes). After successfully adding an event, the user will be redirected to the Events listing page discussed above, and illustrated in the previous figure.

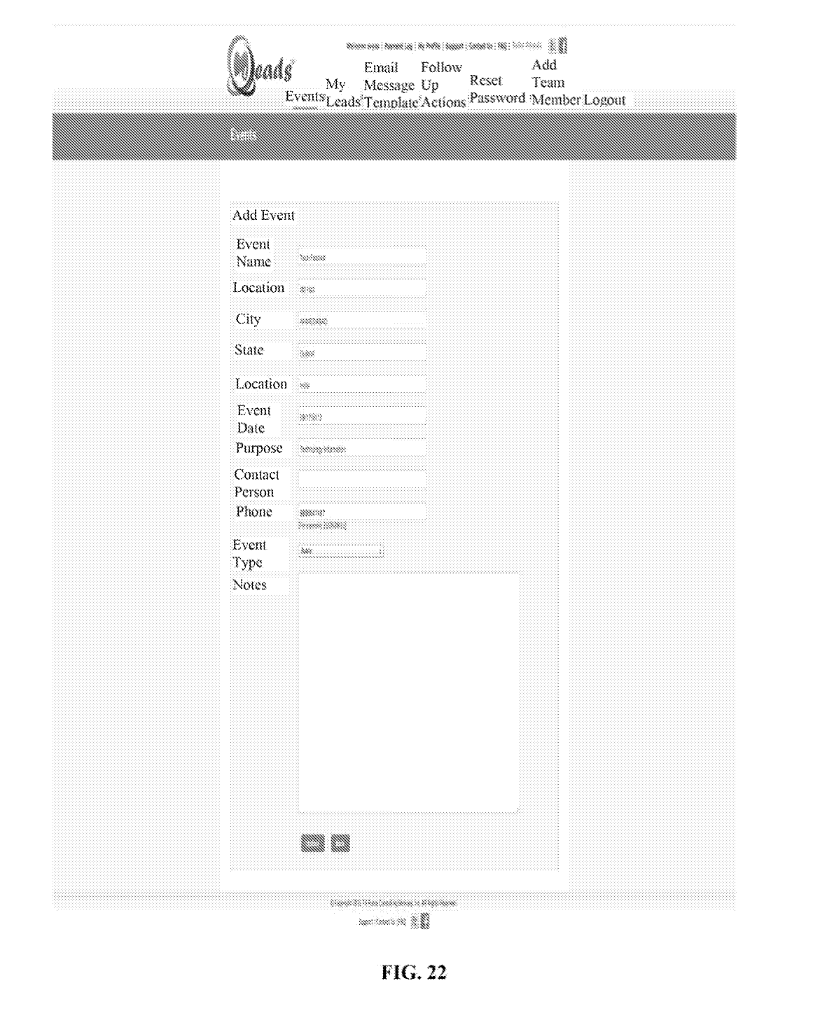

FIG. 22 illustrates the Edit Event page of the website generated by the BLM software. When a user clicks on the edit button in the Events page, the application will be redirected to the Edit Event page illustrated. The user can modify existing event information, and if successfully modified, the user will be redirected once again to the Event page of the website.

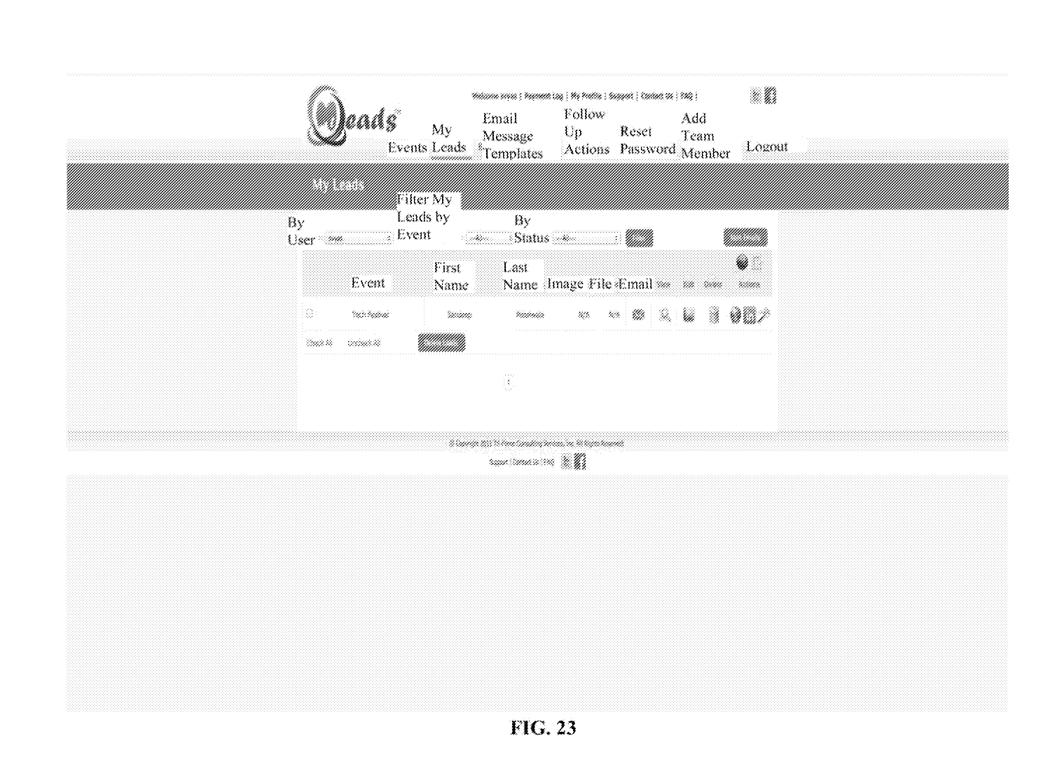

FIG. 23 illustrates the My Leads page of the website generated by the BLM software. On this page the user can see as list of business leads organized by the event at which the business lead was obtained. The user can filter the leads by selecting the the event or team member. Each row of records on the My Leads page will display the event wise lead name, image and file. The user ran perform the following actions: (1) Send Email: When the user selects leads and then clicks on the Sent Emails button, the application will add the lead into sent emails; (2) View Lead: User can view lead details (3) Edit Lead: User can edit/modify existing lead details; (4) Delete Lead: User can delete lead; (5) Google search: User in conduct a Google search with lead first name and last name, and (6) LinkedIn search: User can perform a LinkedIn search with selected lead first name and last name.

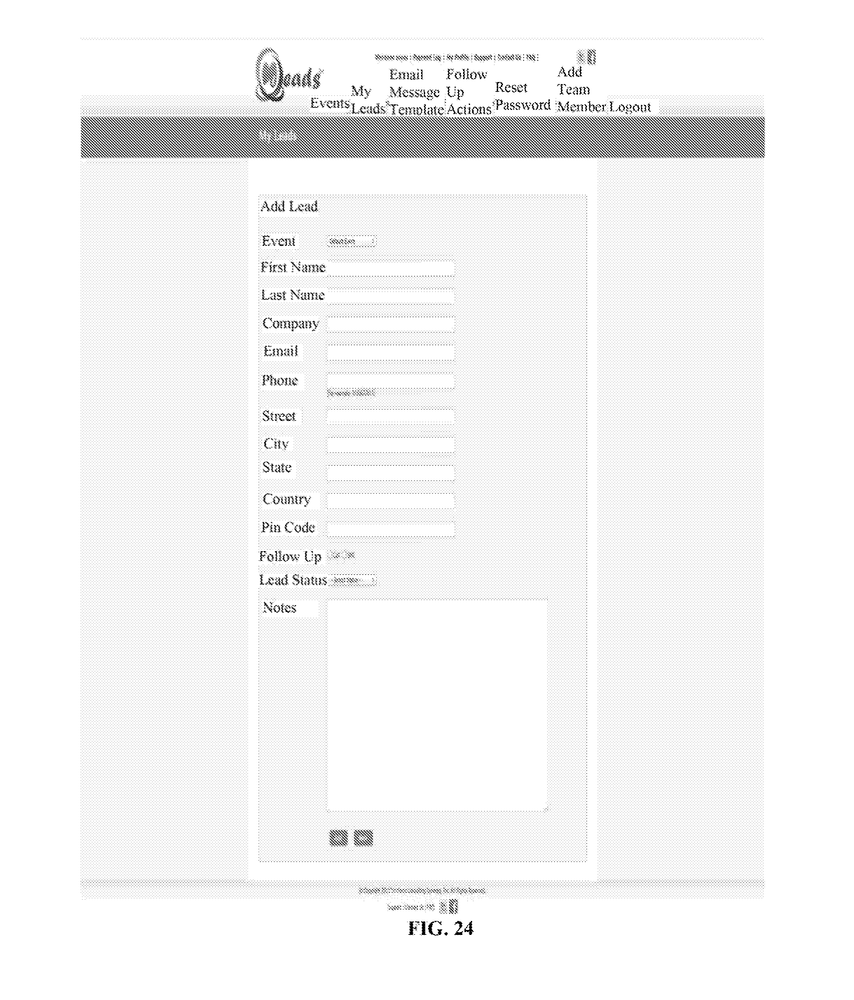

FIG. 24 illustrates the Add Lead page of the website generated by the BLM software. On this page, after filling in the event name, first name, last name, company name, email and phone number, a user can add a lead. Optionally, the user can also provide follow-up actions and notes for that particular lead. If the lead is successfully added, then the user will be informed by receiving a message. After adding the lead, the user will be redirected to the MyLeads.

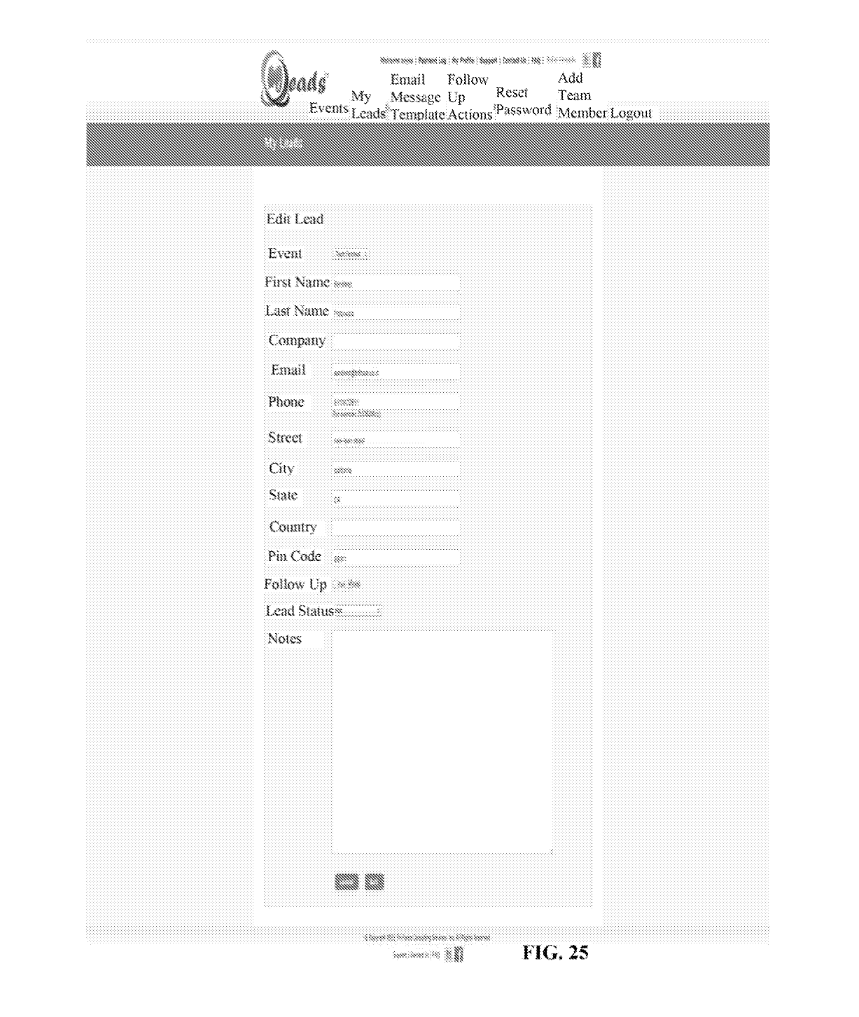

FIG. 25 illustrates the Edit Lead page of the website generated by the BLM software. On this page, all of the details of a particular lead is shown to a user. Furthermore, the user can edit the lead on this page. After editing, the user can click “Update” to submit the updated lead details. If the lead is updated successfully, then the user will be informed by receiving a message. After editing a lead, the user will be redirected to the leads listing screen.

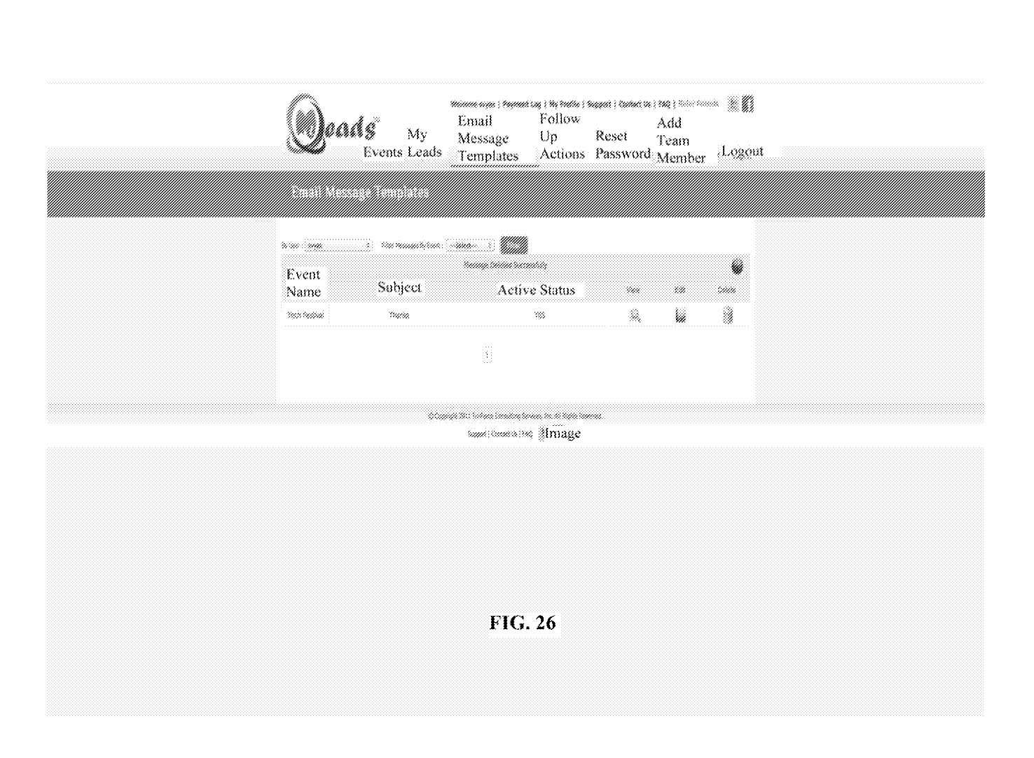

FIG. 26 illustrates the Email Message Template page of the website generated b the BLM software, On this page, the user can see a list of event-wise email message templates, in which each record will display the subject and the message. A user can filter the email message b specifying an event and team member. A user can view, edit, and delete email message templates. By touching the “+” icon at the top right of the screen, a user can add a new email message template. As the user clicks on the delete icon, a dialog box will appear prompting the user to confirm that the user desires to delete that particular message template.

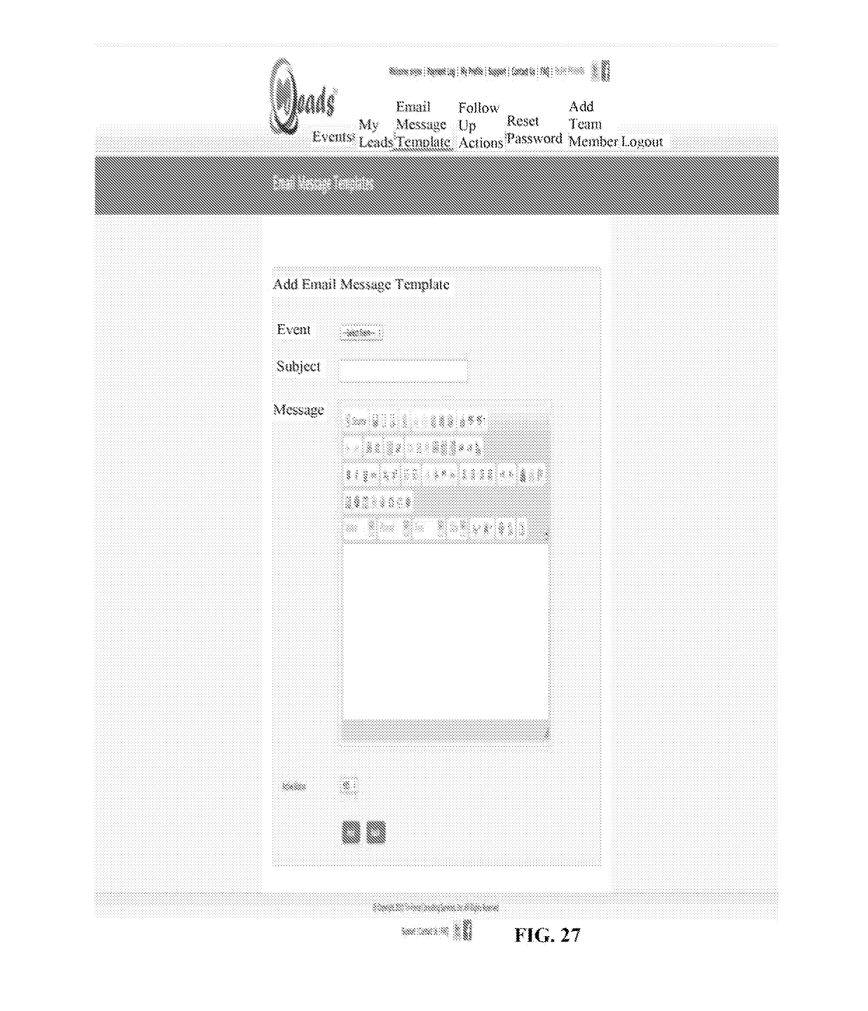

FIG. 27 illustrates the Add Email Message Template page of the website generated by the BLM software. On this page, a user can select a particular event from a drop-down menu. After selecting a particular event, a user can provide a subject and a message and in this manner can add that subject and email as an email message template. Optionally, the user can also provide status (i.e., active or inactive) for that particular message template. The user will click on the “Add” button to finalize the message template details. If the email message template is added successfully, then the user will be informed by receiving a message. After adding the email message template, the user will be redirected to the email message listing screen.

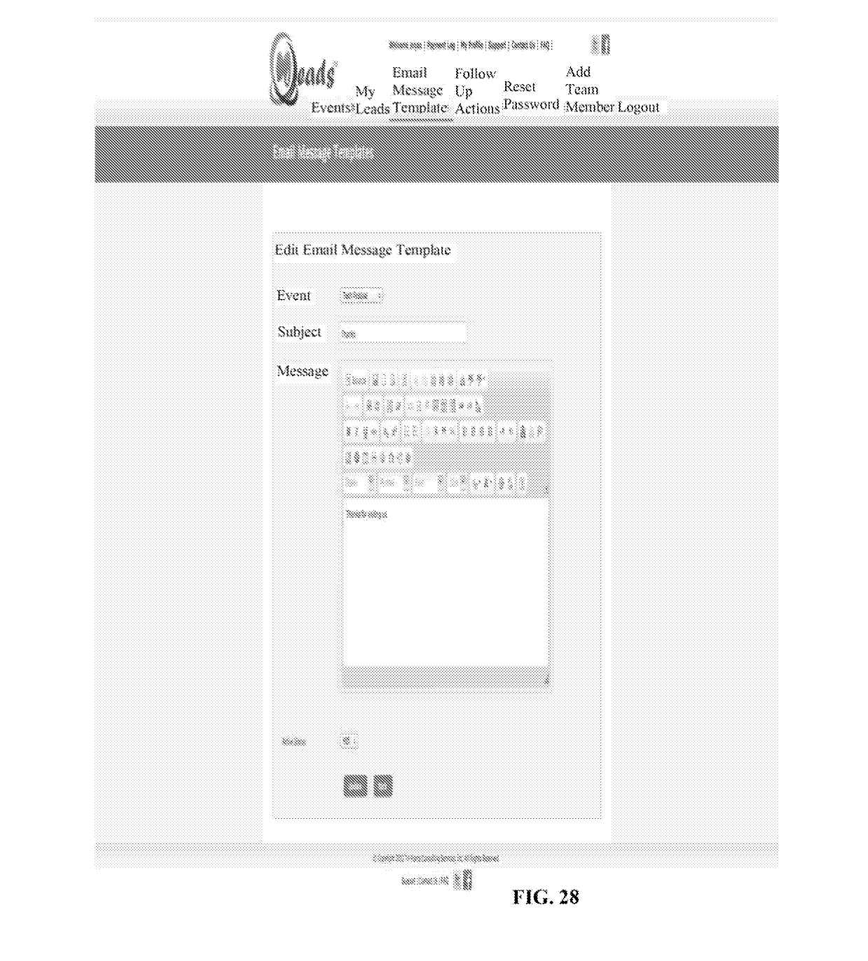

FIG. 28 illustrates the edit email message template page of the website generated by the BLM software. On this page, all of the details of a particular email message template are shown to a user, and can be edited by a user. After editing, a user can click on the “Update” button to save the updated details. If the email message template is updated successfully, then the user will be informed by receiving a message. After editing the email message template, the user will be redirected to an email message listing page.

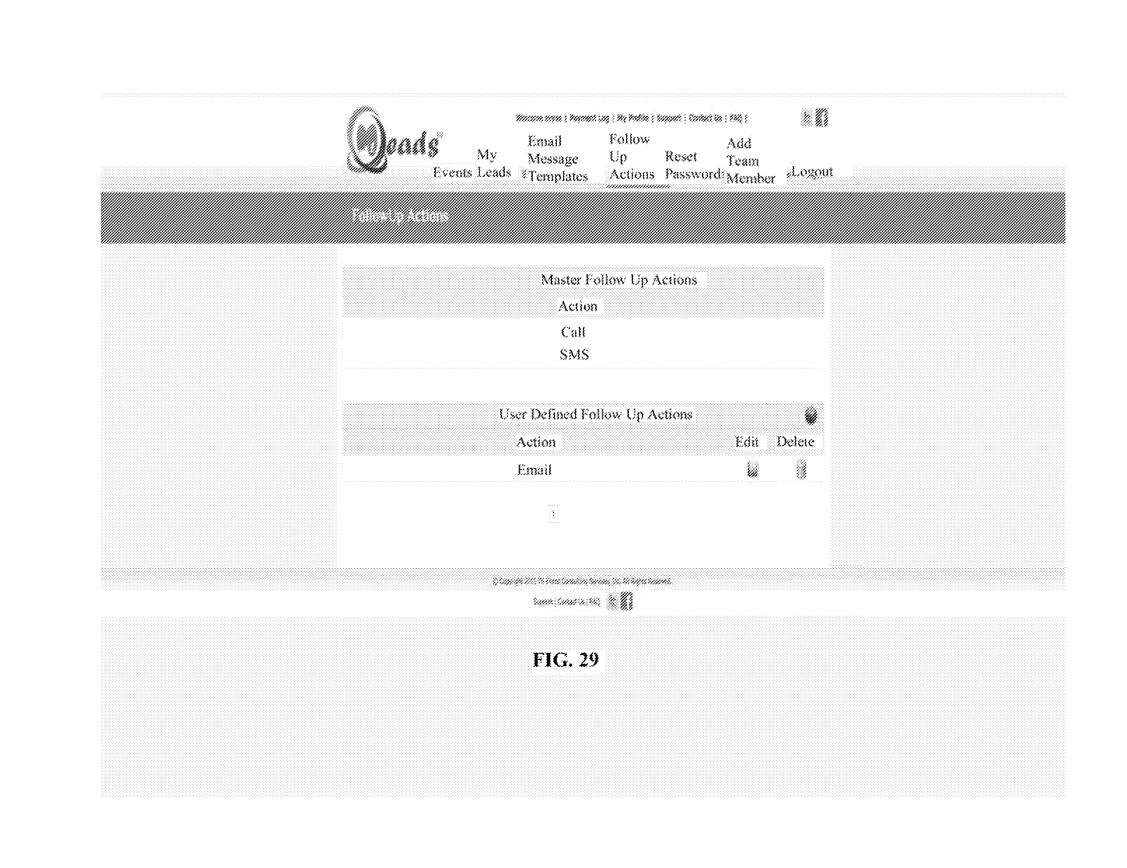

FIG. 29 illustrates a Follow-Up Actions page of the website generated by the BLM software. On this page a user can see a list of follow-up actions, which are preferable methods of communication for a particular event. A user can update or delete user defined follow-up actions. Also, by selecting, the “+” icon at the top right of the page, the user can add a new follow-up action. As a user clicks on the delete icon, a dialog box will appear prompting the user to confirm that he or she desires to delete that particular follow-up action.

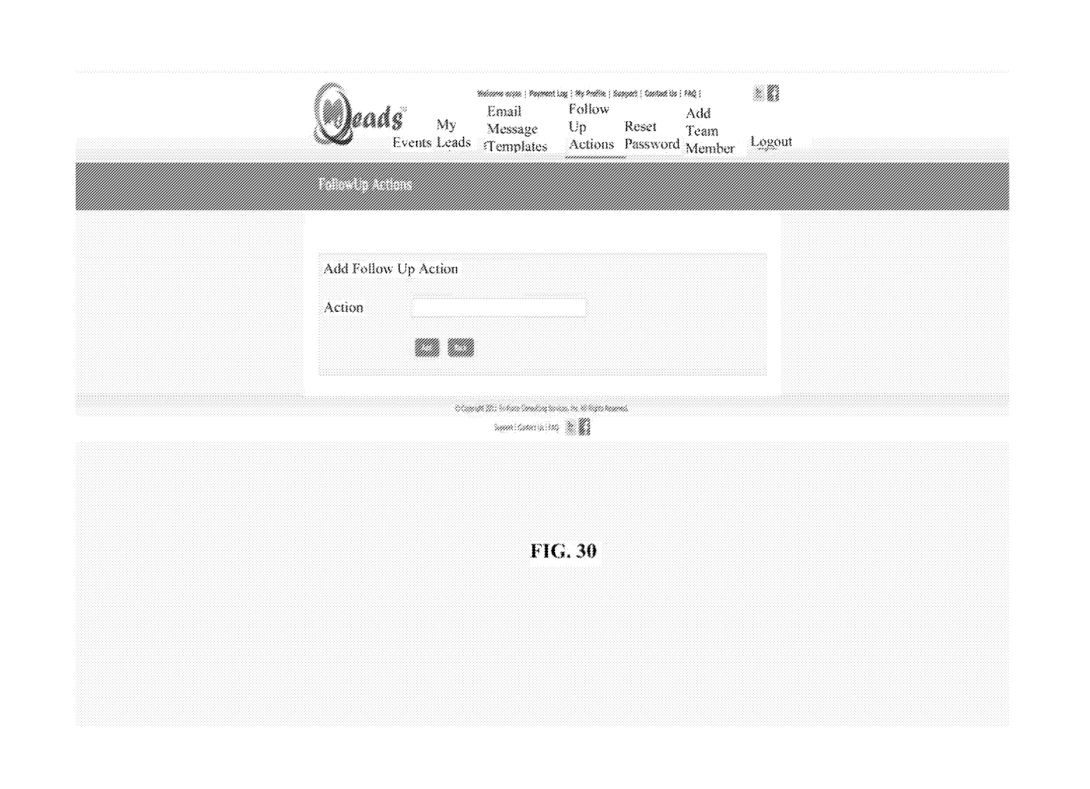

FIG. 30 illustrates the Add Follow-Up Action page of the website generated by the BLM software. On this page, only one field name is required to add a follow-up action (i.e., the Action field). The user can click on the “Add” button to add new follow-up actions. If the follow-up action is successfully added, then the user will be informed by receiving a message. After adding follow-up actions, the user will be redirected to the follow-up actions listing screen.

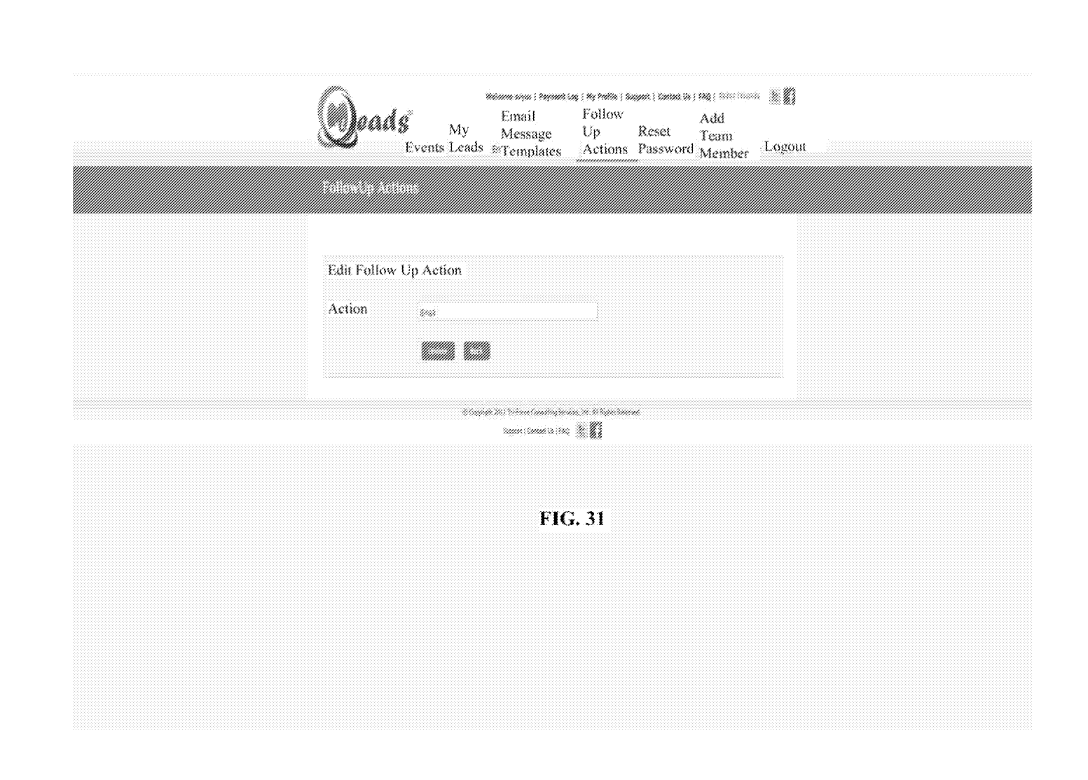

FIG. 31 illustrates the Edit Follow-Up Action page of the website generated b the BLM software. On this page, the details of a particular follow-up action is shown to the user, which can be edited by the user as desired. After editing, the user can click on the “Update” button to update the follow-up action. If the follow-up action is updated successfully, then the user will be informed by receiving a message. After editing the follow-up action, the user will be redirected to the follow-up actions listing screen.

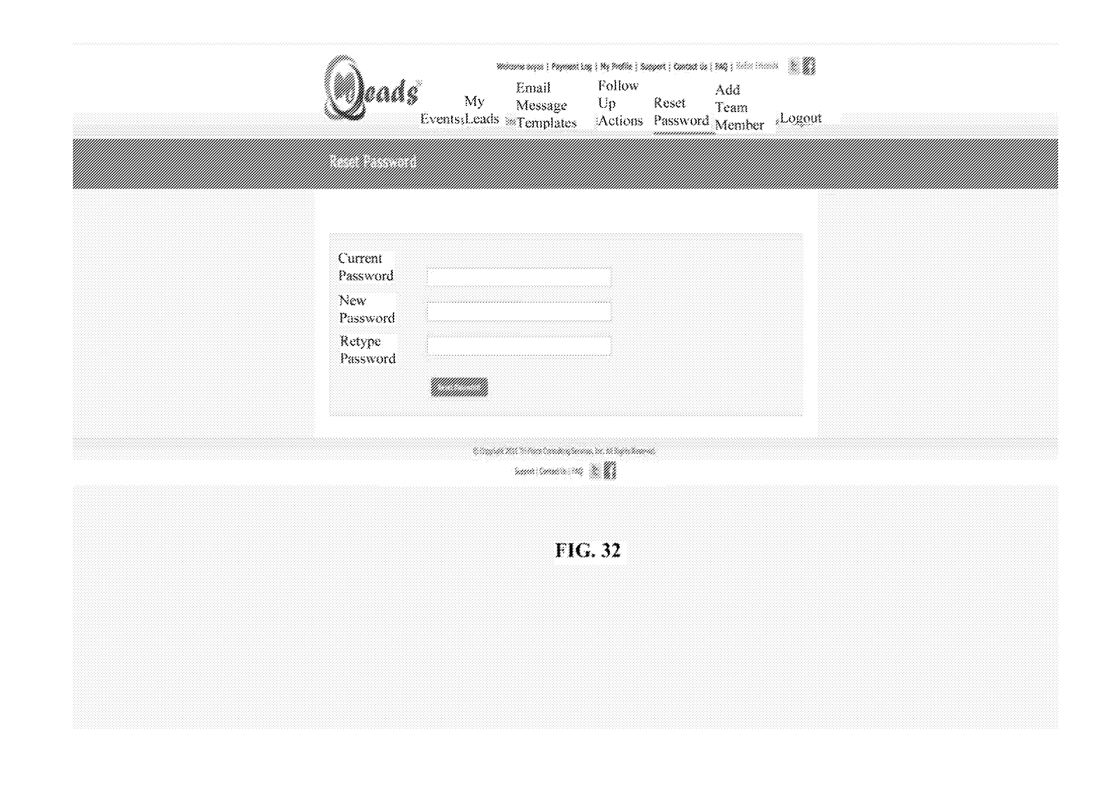

FIG. 32 illustrates the Reset Password page of the website generated by the BLM software, to reset the password, the user fills m the blanks by providing the user's current password, providing a new password, and retyping the new password for confirmation purposes. After filling in these details, the user clicks on the “Save Password” button, if the password reset is completed, then the user will be informed by receiving a message.

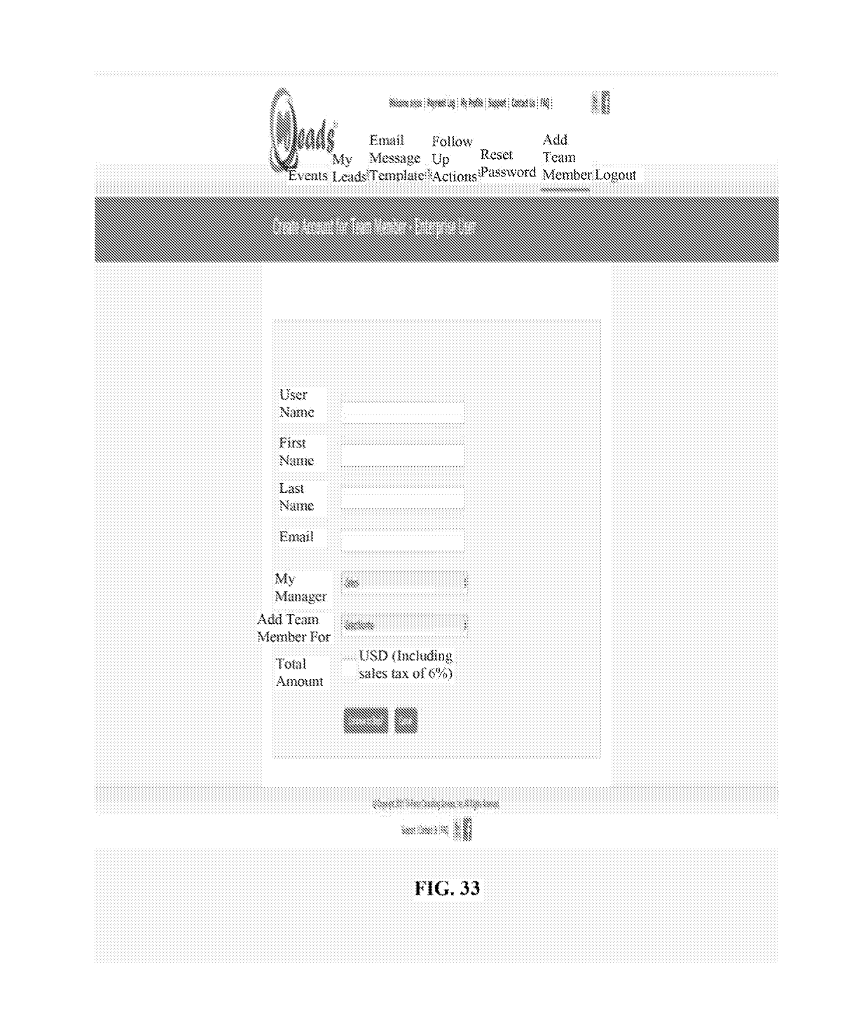

FIG. 33 illustrates the Add Team Member page of the website generated by the BLM software. A user can create/add new team members by specifying the user name, first name, last name, email address, manager, duration of time that the new team member will be added and providing other related information. A manager can view the team member details including events, leads, meetings, tasks, follow-up messages, follow-up actions, and the like.

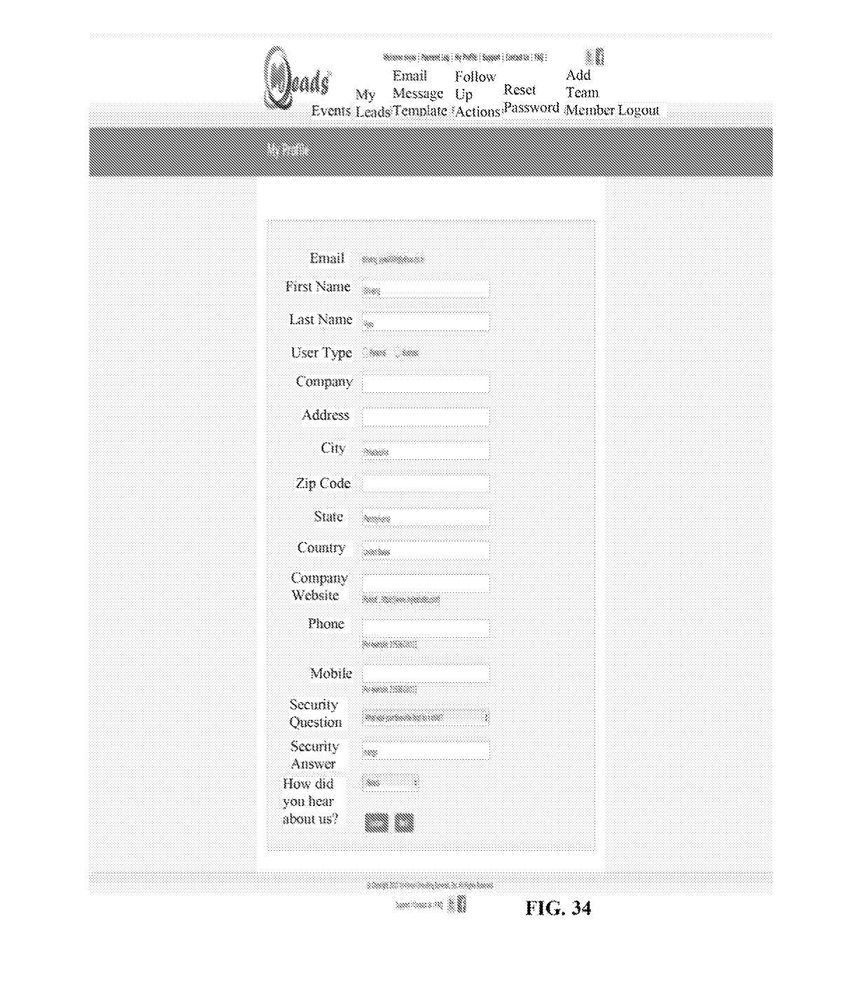

FIG. 34 illustrates the My Profile page of the website generated by the BLM software. On this page, a user can view and edit profile related information including first name, last name, user type (i.e., personal, business), company name, address, company website address, security related information (i.e., security question and answer) and other related information.

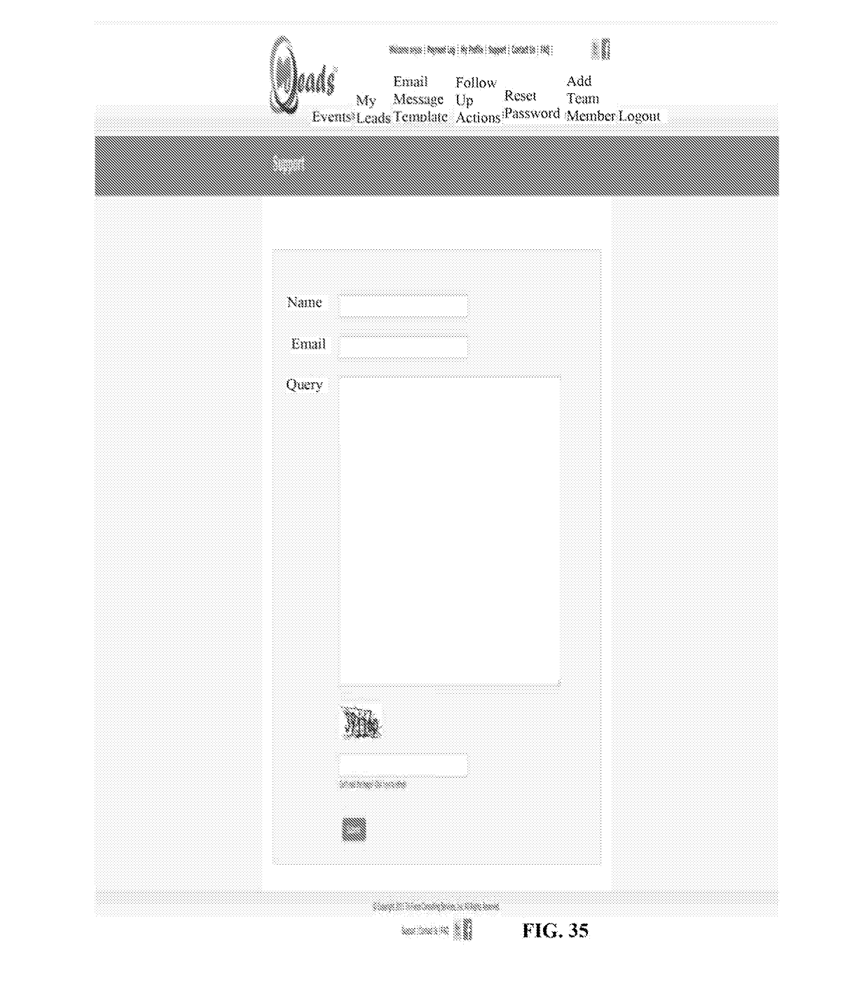

FIG. 35 illustrates the Support Page of the website generated by the BLM software. On this page, the user can receive support by filling in his or her name, email address and query. Furthermore, the Support Page will prompt the user to fill in the verification code. After the user posts the query, it will be transmitted directly to the Admin personnel email address.

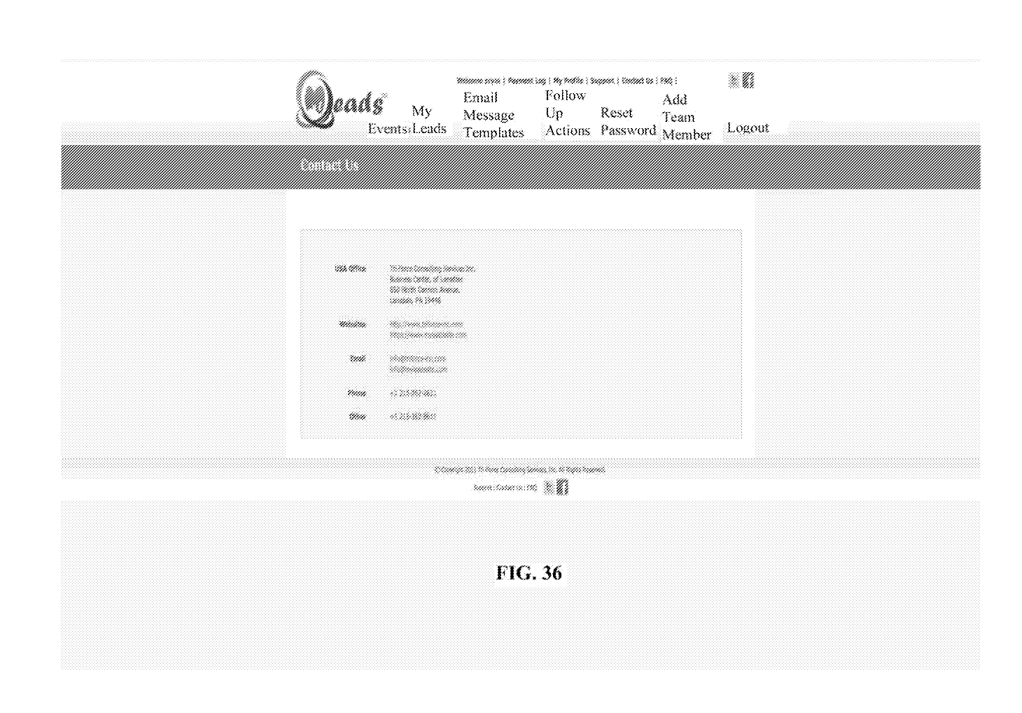

FIG. 36 illustrates the Contact Us Page of the website generated by the BUM software. This page provides a user with the company information, including the website name, email and contact information.

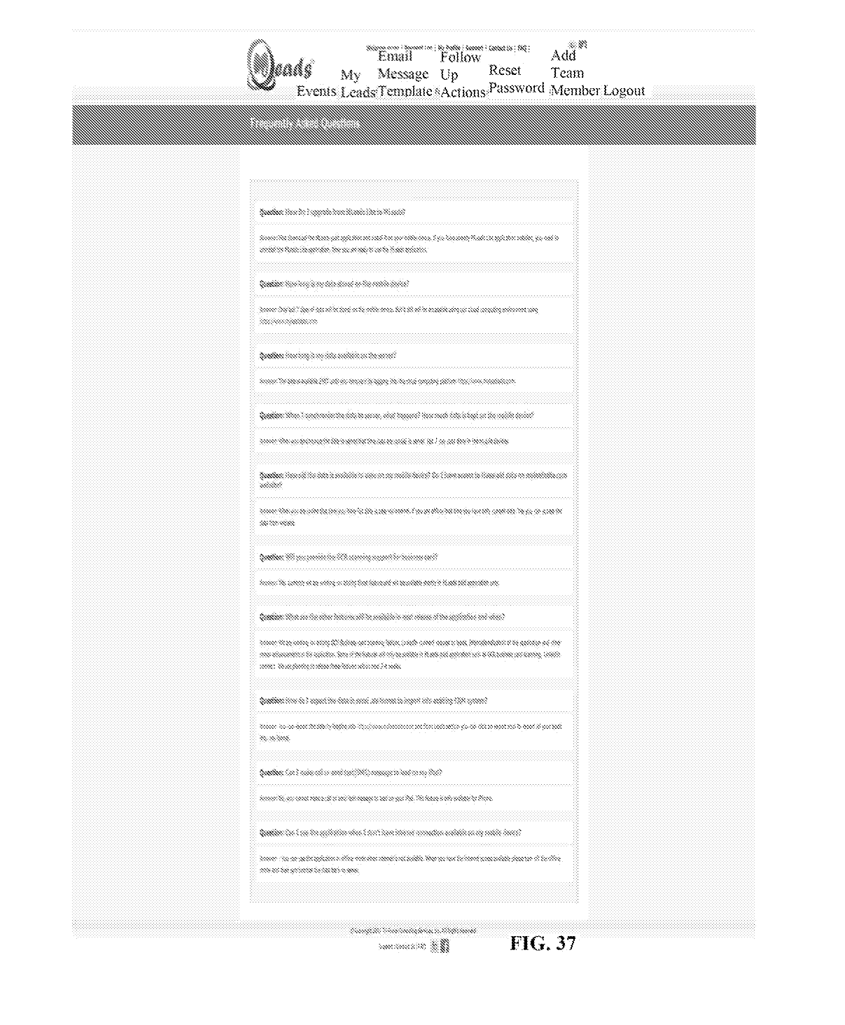

FIG. 37 illustrates the FAQs page (i.e., Frequently Asked Questions) of the website generated by the BLM software. On this page, a user can obtain quick answers to questions that he or she may have. This page includes a list of questions and answers that will be displayed, to provide a user with guidelines about the application and answers to questions that other users may have had.

While the embodiment of the present invention has been described with reference to the accompanying drawings, it can be understood by those skilled in the art that the present invention can be embodied in other specific forms without departing from its spirit or essential characteristics. Therefore, the foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1-41. (canceled)

42. A method of following-up on business leads, the method comprising:
a) storing one or more pre-formed message templates in a message template database using business lead management software;
b) capturing business lead data for one or more business leads and storing the business lead data in a business lead database using, the business lead management software; and
c) upon receiving a message formation request for a selected one of the business leads, the business lead management software automatically generating an electronic message using: (1) the business lead data that is stored in the business lead database for the selected business lead; and (2) a selected one of the pre-formed message templates in the message template database.

43. The method of claim 42 wherein step a) further comprises:
a user fanning a plurality of the pre-formed message templates using the business lead management software, each of the plurality of the pre-formed message templates comprising at least one substitute variable field, and user-defined text; and
storing the plurality of the pre-formed message templates in the message template database.

44. The method of claim 43 wherein step c) further comprises:
the business lead management software retrieving, from the business lead database, a portion of the business lead data for the selected business lead that is associated with the at least one substitute variable field; and
the business lead management software populating the at least one substitute variable field with the retrieved portion of the business lead data in the electronic message.

45. The method of claim 43 wherein, for each of the business leads, the business lead data stored in the business lead database comprises name data and delivery data, and wherein step c) further comprises:
the business lead management software retrieving the deliver data for the selected business lead from the business lead database and populating a delivery address field of the electronic message with the delivery data for the selected business lead; and
the business lead management software retrieving the name data for the selected business lead from the business lead database and populating the at least one substitute variable field with the name data of the selected business lead in the electronic message.

46. The method of claim 42 wherein step c) further comprises:
the business lead management software presenting, on a display device, a list of business leads for which business lead data is stored in the business lead database, each of the business leads of the list, of business leads being selectable;
the business lead management software presenting, on the display device, a list of pre-formed message templates stored on the message template database, each of the pre-formed message templates of the list of pre-formed message templates being selectable;
the business lead management software presenting, on the display device, a message formation element that, when activated, generates the message formation request; and
wherein upon a plurality of the business leads of the list of business leads being concurrently selected, one of the pie-formed message templates of the list of pre-formed message templates being selected, and the message formation element being activated, the business lead management software automatically generates a single electronic message to be sent to delivery addresses of all of the selected business leads using the selected pre-formed message template.

47. The method of claim 42 wherein step c) comprises the business lead management software interfacing with electronic message software to generate a blank electronic message, the business lead management software automatically populating fields of the blank electronic message with the business lead data for the selected business lead that is stored in the business lead database and the selected one of the pre-formed message templates to form the electronic message.

48. The method of claim 42 further comprising:
the business lead management software storing event data for one or more events. attended by a user in an event, database;
wherein step b) further comprises the business lead management software associating the business lead data for the one or more business leads to the event data stored for one of the events in the event database and
wherein step b) further comprises the business lead management software associating the business lead data for the one or more business leads to the event data stored for one of the events in the event database.

49. The method of claim 48 wherein the association of the business lead data to the event data is accomplished b the user selecting one of the events from a list of events presented in a display device, and subsequently capturing the business lead data.

50. The method of claim 48 wherein step c) further comprises upon receiving the message formation request for the selected one of the business leads, the business lead management software automatically generating the electronic message using the business lead data for the selected business lead stored in the business lead database, the selected one of the pre-formed message templates stored in the message template database, and the event data stored in the event database to which the business lead data for the selected business lead is associated.

51. The method of claim 42 wherein step b) further comprises:
the business lead management software presenting, in a display device, a blank business lead template;
the business lead management software receiving business lead data in fields of the blank business lead template inputted by a user; and
the business lead management software storing the inputted business lead data m the business lead database.

52. The method of claim 42 further comprising:
the business lead management software presenting, in a display device, a secondary source of information element;
upon activation of the secondary source of information element, the business lead management software automatically exporting at least a portion of the business lead data of a selected business lead to search fields of an electronic secondary source of information and executing a search of the electronic secondary source of information; and
the business lead management, software executing a software application in which results of the search can be displayed on the display device.

53. A method of evaluating business lead generation by personnel, the method comprising:
a) for each of a plurality of users, capturing business lead data using business lead management software for one or more business leads and storing the business lead data in a business lead database, the business lead management software associating the business lead data with the user whom captured the business lead data; and
b) presenting, in a display device, the business lead data stored in the business lead database that is associated with a selected one of the users.

54. The method of claim 53 further comprising:
storing, in an event database, event data for events attended by each of the users; and
associating the business lead data with the event at which the business lead data was captured.

55. The method of claim 54 wherein step b) further comprises:
presenting, in the display device, the business lead data of the business lead database that is associated with the selected one of the users and a selected one of the events.

56. The method of claim of claim 53 wherein step b) further comprises:
the business lead management software presenting, in a display device, a list of users, each of the users in the list of users being selectable;
upon one of the users being selected, from the list of users, the business lead management software presenting, in the display device, a list of events attended by the selected user, the list of events being generated from event data stored in an event database that is associated with the selected user, each of the events in the list of events being selectable; and
upon one of the events being selected from the list of events, the business lead management software presenting, in the display device, a list of business leads that is generated from the business lead data stored in the business lead database that is associated with the selected user.

57. The method of claim 53 wherein step a) further comprises, for each user:
obtaining an image of a business card comprising business lead data;
the business lead management software identifying the business lead data on the business card using optical character recognition and parsing, the identified business lead data
the business lead management software presenting, in a display device, the parsed business lead data for user confirmation arid/or editing, and
upon the user confirming accuracy of the parsed business lead data, the business lead management software storing the confirmed business lead data in the business lead database.

58. The method of claim 53 wherein step a) further comprises, for each user
scanning a matrix bar code on a business card to obtain the business lead data; and
the business lead management software storing the business lead data in the business lead database.

59. A method of following-up on business leads, the method comprising:
a) capturing business lead data for one or more business leads and storing the business lead data in a business lead database using business lead management software;
b) the business lead management software presenting, in a display device, a secondary source of information element;
c) upon activation of the secondary source of information element, the business lead management software automatically exporting at least a portion of the business lead data of an electronic secondary source of information; and
d) presenting, in the display device, an interface in which a result of the electronic secondary source of information based on the exported portion of the business lead data is displayed.

60. The method of claim 59 wherein step c) further comprises the business lead management software automatically exporting the portion of the business lead data of the selected business lead to search fields of the electronic secondary source of information and executing a search of the electronic secondary source of information.
